(19) United States
(12) Patent Application Publication
(10) Pub. No.: US 2013/0241972 A1
(43) Pub. Date: Sep. 19, 2013

(54) METHOD OF DRIVING PLASMA DISPLAY DEVICE AND PLASMA DISPLAY DEVICE

(71) Applicants: Takahiko Origuchi, Osaka (JP); Yuya Shiozaki, Osaka (JP); Naoyuki Tomioka, Osaka (JP); Hidehiko Shoji, Osaka (JP)

(72) Inventors: Takahiko Origuchi, Osaka (JP); Yuya Shiozaki, Osaka (JP); Naoyuki Tomioka, Osaka (JP); Hidehiko Shoji, Osaka (JP)

(73) Assignee: PANASONIC CORPORATION, Osaka (JP)

(21) Appl. No.: 13/990,014

(22) PCT Filed: Dec. 1, 2011
(86) PCT No.: PCT/JP2011/006730

§ 371 Date: May 28, 2013

(30) Foreign Application Priority Data
Dec. 2, 2010 (JP) 2010-268986

(51) Int. Cl. G09G 3/298

(52) U.S. Cl. CPC G09G 3/298
USPC 345/690; 345/60

(57) ABSTRACT

In a plasma display apparatus, contrast is enhanced and a stable address discharge is caused. For this purpose, one of a forced initializing operation and a selective initializing operation is performed in initializing periods. A specified-cell initializing subfield and a selective initializing subfield are set in one field. In the specified-cell initializing subfield, the forced initializing operation is performed on specified discharge cells and the selective initializing operation is performed on the other discharge cells. In the selective initializing subfield, the selective initializing operation is performed on all the discharge cells. In the selective initializing period, a down-ramp waveform voltage is applied to the scan electrodes and a positive voltage is applied to the data electrodes. In the selective initializing subfield, based on the load calculated in the address period of the immediately preceding subfield, the minimum voltage of the down-ramp waveform voltage is controlled.

### TECHNICAL FIELD

The present invention relates to a driving method for a plasma display apparatus, which is an image display apparatus that includes a plasma display panel of the AC surface discharge type, and to the plasma display apparatus.

### BACKGROUND ART

An AC surface discharge panel typically used as a plasma display panel (hereinafter simply referred to as “panel”) has a large number of discharge cells that are formed between a front substrate and a rear substrate facing each other. With the front substrate, a plurality of display electrode pairs, each formed of a scan electrode and a sustain electrode, is disposed on a front glass substrate parallel to each other. A dielectric layer and a protective layer are formed so as to cover the display electrode pairs.

With the rear substrate, a plurality of parallel data electrodes is formed on a rear glass substrate, and a dielectric layer is formed so as to cover the data electrodes. Further, a plurality of barrier ribs is formed on the dielectric layer parallel to the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. The sealed inside discharge space is filled with a discharge gas containing xenon in a partial pressure ratio of 5%, for example. Discharge cells are formed in the parts where the display electrode pairs face the data electrodes. In the thus structured panel, a gas discharge generates ultraviolet rays in each discharge cell. These ultraviolet rays excite the red (R), green (G), and blue (B) phosphors such that the phosphors of the respective colors emit light for color image display.

A typically used method for driving the panel is a subfield method. In the subfield method, one field is divided into a plurality of subfields, and gradations are displayed by causing light emission or no light emission in each discharge cell in each subfield. Each subfield has an initializing period, an address period, and a sustain period.

In the initializing periods, an initializing operation is performed so as to apply an initializing waveform to the respective scan electrodes and cause an initializing discharge in the respective discharge cells. This initializing operation forms wall charge necessary for the subsequent address operation in the respective discharge cells and generates priming particles (excitation particles for causing a discharge) for causing a stable address discharge.

The initializing operation includes the following two types: a forced initializing operation and a selective initializing operation. The forced initializing operation forcedly causes an initializing discharge in the discharge cells regardless of the operation in the immediately preceding subfield. The selective initializing operation selectively causes an initializing discharge only in the discharge cells having undergone an address discharge in the address period of the immediately preceding subfield.

In the address periods, a scan pulse is sequentially applied to the scan electrodes, and an address pulse in response to signals of an image to be displayed is applied selectively to the data electrodes. Thus, an address discharge is caused between the scan electrodes and the data electrodes so as to form wall charge in the discharge cells to be lit (hereinafter these operations being also generically referred to as “addressing”).

In each sustain period, a number of sustain pulses based on a luminance weight predetermined for the subfield are applied alternately to display electrode pairs, each formed of a scan electrode and a sustain electrode. This operation causes a sustain discharge in the discharge cells having undergone the address discharge, thus causing the phosphor layers of the discharge cells to emit light. (Hereinafter, causing a discharge cell to be lit by a sustain discharge is also denoted as “lighting”, and causing a discharge cell not to be lit as “non-lighting”). Thereby, the respective discharge cells are lit at luminances corresponding to the luminance weights. In this manner, the respective discharge cells of the panel are lit at the luminances corresponding to the gradation values of the image signals. Thus, an image is displayed in the image display area of the panel.

The light emission caused by a sustain discharge is a light emission related to gradation display. In contrast, the light emission caused by a forced initializing operation in the initializing period is a light emission unrelated to gradation display.

One of the important factors in enhancing the quality of an image displayed on the panel is to enhance contrast. As one of the subfield methods for driving a panel, the following driving method is disclosed. In this method, the contrast of the image displayed on the panel is enhanced by minimizing the light emission unrelated to gradation display (see Patent Literature 1, for example).

In this driving method, a forced initializing operation for causing an initializing discharge in all the discharge cells is performed in the initializing period of one subfield among a plurality of subfields forming one field. In the initializing periods of the other subfields, a selective initializing operation is performed.

When a forced initializing operation is performed, the scan electrodes are applied with a ramp waveform voltage that has a gentle ramp portion where the voltage gradually rises and a gentle ramp portion where the voltage gradually falls. This voltage application prevents a strong discharge and thus occurrence of a strong light emission in the discharge cells in the forced initializing operation.

The luminance of a region displaying black where no sustain discharge occurs (hereinafter simply referred to as “luminance of black level”) changes depending on the light emission that occurs regardless of the magnitude of the gradation value. This light emission includes a light emission caused by a forced initializing operation.

In the driving method described in Patent Literature 1, the forced initializing operation is performed once in one field. Thus, the light emission in the region displaying black is determined by a weak light emission in the forced initializing operation. This can reduce the luminance of black level of an image displayed on the panel and display an image of high contrast on the panel in comparison with the case where the forced initializing operation is performed on all the discharge cells in each subfield.

In recent years, increasing the screen size and definition of the panel has been in demand. In a large, high-definition panel, not only the number of electrodes but also the impedance when the electrodes are driven are increased. Thus, in such a panel, the electric power consumption is likely to increase. As a result, a voltage drop in the driving waveforms applied to the electrodes is likely to occur.

The voltage drop in the driving waveforms can destabilize a discharge in the discharge cells and degrade the image display quality in the panel.

On the other hand, as the screen size and definition of the panel increase, further enhancement in the image display quality is in demand.

### CITATION LIST

### Patent Literature

PTL1
Japanese Patent Unexamined Publication No. 2000-242224

### SUMMARY OF THE INVENTION

In a driving method for a plasma display apparatus of the present invention, a panel has a plurality of discharge cells, each of the discharge cells has a display electrode pair and a data electrode, and the display electrode pair includes a scan electrode and a sustain electrode. Further, gradations are displayed on the panel in a manner such that a plurality of subfields, each having an initializing period, an address period, and a sustain period, is set in one field. In this driving method, one of a forced initializing operation and a selective initializing operation is performed in the initializing period. The forced initializing operation causes an initializing discharge in the discharge cells. The selective initializing operation causes an initializing discharge selectively in the discharge cells having undergone an address discharge in the immediately preceding subfield. A specified-cell initializing subfield and a selective initializing subfield are set in the one field. The specified-cell initializing subfield includes an initializing period where the forced initializing operation is performed on specified discharge cells and the selective initializing operation is performed on the other discharge cells. The selective initializing subfield includes an initializing period where the selective initializing operation is performed on all the discharge cells. In the selective initializing period, a down-ramp waveform voltage is applied to the scan electrodes and a positive voltage is applied to the data electrodes. In the selective initializing subfield, based on the load calculated when the data electrodes are driven in the address period of the immediately preceding subfield, the minimum voltage of the down-ramp waveform voltage is controlled.

This method can enhance the contrast of the display image and thus the image display quality of the plasma display apparatus, and cause a stable address discharge by sufficiently adjusting the wall charge generated by the initializing discharge, even in the plasma display apparatus that includes a large, high-definition panel where an increased number of electrodes are likely to increase the impedance when the electrodes are driven.

In this driving method, the load value of each discharge cell is calculated based on the image data representing light emission or no light emission in each discharge cell in each subfield that is set in response to an image signal. By cumulatively-adding the load values, the load when the data electrodes are driven in the address period is calculated.

In this driving method, the minimum voltage of the down-ramp waveform voltage is lowered in the selective initializing period of a subfield where the magnitude of the load exceeds a threshold.

A plasma display apparatus of the present invention includes the following elements:

a panel having a plurality of discharge cells, each of the discharge cells having a display electrode pair and a data electrode, the display electrode pair including a scan electrode and a sustain electrode; and

a driver circuit for displaying gradations on the panel in a manner such that a plurality of subfields, each having an initializing period, an address period, and a sustain period, is set in one field.

In this plasma display apparatus, the driver circuit performs one of a forced initializing operation and a selective initializing operation in the initializing period. The forced initializing operation causes an initializing discharge in the discharge cells. The selective initializing operation causes an initializing discharge selectively in the discharge cells having undergone an address discharge in the immediately preceding subfield. A specified-cell initializing subfield and a selective initializing subfield are set in the one field. The specified-cell initializing subfield includes an initializing period where the forced initializing operation is performed on specified discharge cells and the selective initializing operation is performed on the other discharge cells. The selective initializing subfield includes an initializing period where the selective initializing operation is performed on all the discharge cells. In the selective initializing period, the driver circuit applies a down-ramp waveform voltage to the scan electrodes and applies a positive voltage to the data electrodes. In the selective initializing subfield, based on the load calculated when the data electrodes are driven in the address period of the immediately preceding subfield, the minimum voltage of the down-ramp waveform voltage is controlled.

This configuration can enhance the contrast of the display image and thus the image display quality of the plasma display apparatus, and cause a stable address discharge by sufficiently adjusting the wall charge generated by the initializing discharge, even in the plasma display apparatus that includes a large, high-definition panel where an increased number of electrodes are likely to increase the impedance when the electrodes are driven.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a chart schematically showing driving voltage waveforms applied to the respective electrodes of the panel for use in the plasma display apparatus in accordance with the exemplary embodiment.

FIG. 4 is a diagram schematically showing an example of circuit blocks forming the plasma display apparatus in accordance with the exemplary embodiment.

FIG. 5 is a circuit diagram schematically showing a configuration example of a scan electrode driver circuit in accordance with the exemplary embodiment.

FIG. 6 is a circuit diagram schematically showing a configuration of a data electrode driver circuit in accordance with the exemplary embodiment.

FIG. 7 is a partially enlarged chart of an example of a lighting pattern displayed on the panel in the plasma display apparatus in accordance with the exemplary embodiment.

FIG. 8 is a partially enlarged chart of another example of the lighting pattern displayed on the panel in the plasma display apparatus in accordance with the exemplary embodiment.

FIG. 9A is a chart schematically showing an example of a lighting pattern of discharge cells adjacent to each other in the plasma display apparatus in accordance with the exemplary embodiment.

FIG. 9B is a chart schematically showing another example of the lighting pattern of the discharge cells adjacent to each other in the plasma display apparatus in accordance with the exemplary embodiment.

FIG. 9C is a chart schematically showing still another example of the lighting pattern of the discharge cells adjacent to each other in the plasma display apparatus in accordance with the exemplary embodiment.

FIG. 9D is a chart schematically showing yet another example of the lighting pattern of the discharge cells adjacent to each other in the plasma display apparatus in accordance with the exemplary embodiment.

FIG. 9E is a chart schematically showing still another example of the lighting pattern of the discharge cells adjacent to each other in the plasma display apparatus in accordance with the exemplary embodiment.

FIG. 10 is a diagram schematically showing an example of an image pattern displayed on the panel in the plasma display apparatus in accordance with the exemplary embodiment.

FIG. 11 is a graph schematically showing an example of a voltage drop in an address pulse in the plasma display apparatus in accordance with the exemplary embodiment.

### DESCRIPTION OF EMBODIMENT

Hereinafter, a description is provided for a plasma display apparatus in accordance with an exemplary embodiment of the present invention with reference to the accompanying drawings.

### Exemplary Embodiment

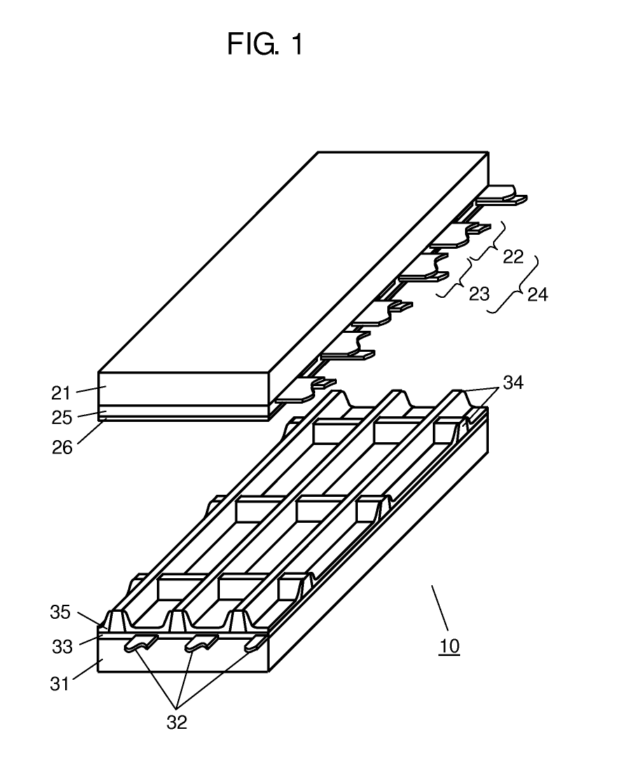

FIG. 1 is an exploded perspective view showing a structure of panel 10 for use in the plasma display apparatus in accordance with the exemplary embodiment of the present invention.

A plurality of display electrode pairs 24, each formed of scan electrode 22 and sustain electrode 23, is arranged on glass front substrate 21. Dielectric layer 25 is formed so as to cover scan electrodes 22 and sustain electrodes 23. Protective layer 26 is formed over dielectric layer 25.

In order to lower a discharge start voltage in discharge cells, protective layer 26 is formed of a material predominantly composed of magnesium oxide (MgO). MgO has proven performance as a panel material, and has a large secondary electron emission coefficient and excellent durability when neon (Ne)-xenon (Xe) gas is sealed.

Protective layer 26 may be formed of one layer, or a plurality of layers. Further, particles may be present on the layers.

A plurality of data electrodes 32 is arranged on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layer 35R for emitting red (R) light, phosphor layer 35G for emitting green (G) light, or phosphor layer 35B for emitting blue (B) light is formed. Hereinafter, phosphor layer 35R, phosphor layer 35G, and phosphor layer 35B are also collectively denoted as phosphor layers 35.

Front substrate 21 and rear substrate 31 face each other such that display electrode pairs 24 intersect data electrodes 32 with a small space sandwiched between the electrodes. Thereby, a discharge space is formed in the gap between front substrate 21 and rear substrate 31. The outer peripheries of the substrates are sealed with a sealing material, such as glass frit. A neon-xenon mixture gas, for example, is sealed into the discharge space, as a discharge gas.

The discharge space is partitioned into a plurality of compartments by barrier ribs 34. Discharge cells are formed in the intersecting parts of display electrode pairs 24 and data electrodes 32.

Discharge and light emission of phosphor layers 35 (lighting) in these discharge cells allow display of a color image on panel 10.

In panel 10, three consecutive discharge cells arranged in the extending direction of display electrode pair 24 form one pixel. These three discharge cells are a discharge cell having phosphor layer 35R and emitting red (R) light (a red discharge cell), a discharge cell having phosphor layer 35G and emitting green (G) light (a green discharge cell), and a discharge cell having phosphor layer 35B and emitting blue (B) light (a blue discharge cell).

The structure of panel 10 is not limited to the above. The panel may include barrier ribs in a stripe pattern, for example.

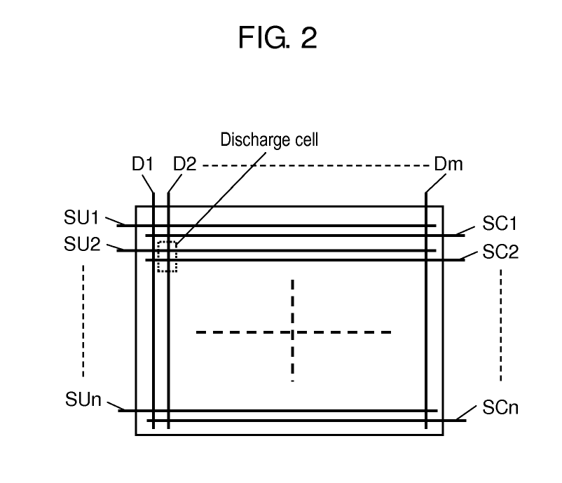

FIG. 2 is an electrode array diagram of panel 10 for use in the plasma display apparatus in accordance with the exemplary embodiment of the present invention.

Panel 10 has n scan electrode SC1-scan electrode SCn (scan electrodes 22 in FIG. 1) and n sustain electrode SU1-sustain electrode SUn (sustain electrodes 23 in FIG. 1) extending in the horizontal direction (i.e. row direction and line direction), and m data electrode D1-data electrode Dm (data electrodes 32 in FIG. 1) extending in the vertical direction (i.e. column direction).

A discharge cell is formed in the part where a pair of scan electrode SCi (i=1-n) and sustain electrode SUi intersects one data electrode Dj (j=1-m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

In this exemplary embodiment, n=768. However, the present invention is not limited to this numerical value.

Next, driving voltage waveforms for driving panel 10 and the operation thereof are outlined.

The plasma display apparatus of this exemplary embodiment drives panel 10 by a subfield method. In the subfield method, one field in an image signal is divided into a plurality of subfields along a temporal axis, and a luminance weight is set for each subfield. Thus, each field has a plurality of subfields having different luminance weights.

Each subfield has an initializing period, an address period, and a sustain period. In response to image signals, light emission and no light emission in the respective discharge cells are controlled in each subfield. That is, a plurality of gradations in response to image signals is displayed on panel 10 by combining lighting subfields and non-lighting subfields in response to image signals.

In each initializing period, an initializing operation is performed so as to cause an initializing discharge in the discharge cells and form wall charge necessary for an address discharge in the subsequent address period on the respective electrodes.

In each address period, a scan pulse is applied to scan electrodes 22 and an address pulse is applied selectively to data electrodes 32 so as to cause an address discharge selectively in the discharge cells to be lit. Thus, an address operation is performed so as to form wall charge for causing a sustain discharge in the subsequent sustain period in the discharge cells.

In each sustain period, a sustain operation is performed in the following manner. Sustain pulses equal in number to the luminance weight set for the subfield multiplied by a predetermined proportionality factor are applied alternately to scan electrodes 22 and sustain electrodes 23. Thus, a sustain discharge is caused in the discharge cells having undergone an address discharge in the immediately preceding address period so as to light the discharge cells. This proportionality factor is a luminance magnification. For instance, when the luminance magnification is 2, four sustain pulses are applied to each of scan electrodes 22 and sustain electrodes 23 in the sustain period of a subfield having the luminance weight “2”. Thus, the number of sustain pulses generated in the sustain period is 8.

The luminance weight represents a ratio of the magnitude of the luminance to be displayed in each subfield. In the sustain period of each subfield, sustain pulses corresponding in number to the luminance weight are generated. Thus, the luminance of a light emission in a subfield having the luminance weight “8” is approximately eight times as high as that in a subfield having the luminance weight “1”, and is approximately four times as high as that in a subfield having the luminance weight “2”.

For instance, suppose one field is formed of eight subfields (subfield SF1, subfield SF2, subfield SF3, subfield SF4, subfield SF5, subfield SF6, subfield SF7, and subfield SF8), and subfield SF1 through subfield SF8 have respective luminance weights of 1, 2, 4, 8, 16, 32, 64, and 128. In this case, the respective discharge cells can display 256 gradations values, using the gradation value “0” through the gradation value “255”.

Light emission is caused selectively in the respective subfields by controlling light emission and no light emission in the respective discharge cells in each subfield in combination in response to image signals. Thereby, the respective discharge cells are lit with various gradation values and thus an image can be displayed on panel 10.

In the present invention, the number of subfields forming one field, the luminance weight of each subfield, or the like is not limited to the above numerical values.

The initializing operations include the following two types: a “forced initializing operation” for causing an initializing discharge in the discharge cells regardless of the operation in the immediately preceding subfield; and a “selective initializing operation” for selectively causing an initializing discharge only in the discharge cells having undergone an address discharge in the address period and a sustain discharge in the sustain period of the immediately preceding subfield. In the forced initializing operation, a rising up-ramp waveform voltage and a falling down-ramp waveform voltage are applied to scan electrodes 22 so as to cause an initializing discharge in all the discharge cells in the image display area.

In the initializing period of one subfield among the plurality of subfields forming one field, a “specified-cell initializing operation” is performed. In the initializing periods of the other subfields, a selective initializing operation is performed on all the discharge cells.

The specified-cell initializing operation is an initializing operation for performing a forced initializing operation in specified discharge cells and performing a selective initializing operation in the other discharge cells. Thus, in the initializing period where a specified-cell initializing operation is performed, a forced initializing waveform for causing a forced initializing operation is applied to the specified discharge cells, and a selective initializing waveform for causing a selective initializing operation is applied to the other discharge cells. Hereinafter, the initializing period where a specified-cell initializing operation is performed is referred to as “specified-cell initializing period”, and a subfield including a specified-cell initializing period is referred to as “specified-cell initializing subfield”. An initializing period where a selective initializing operation is performed on all the discharge cells is referred to as “selective initializing period”, and a subfield including a selective initializing period is referred to as “selective initializing subfield”.

In this exemplary embodiment, a description is provided for an example where one field is divided into 10 subfields, i.e. subfield SF1 through subfield SF10, and subfield SF1-subfield SF10 have respective luminance weights of 1, 2, 3, 6, 11, 18, 30, 44, 60, and 80. Subfield SF1 is a specified-cell initializing subfield, and subfield SF2-subfield SF10 are selective initializing subfields.

In this exemplary embodiment, the first subfield (subfield SF1) of each field is a specified-cell initializing subfield, and the other subfields are selective initializing subfields.

In this exemplary embodiment, panel 10 is driven in a manner such that a “first field” and a “second field” are alternately repeated. The discharge cells undergoing a forced initializing operation in the specified-cell initializing subfield of the first field are different from those undergoing a forced initializing operation in the specified-cell initializing subfield of the second field. Hereinafter, a generation pattern of the forced initializing operation is described.

In this exemplary embodiment, in the specified-cell initializing subfield of a first field, a forced initializing operation is performed on the discharge cells formed on scan electrodes 22 in odd-numbered positions. In the specified-cell initializing subfield of a second field, a forced initializing operation is performed on the discharge cells formed on scan electrodes 22 in even-numbered positions. A “first field” and a “second field” are generated alternately. With this structure, in this exemplary embodiment, a forced initializing operation is performed on each discharge cell once in two fields.

In this exemplary embodiment, driving panel 10 in this manner minimizes the light emission that is the factor in increasing the luminance of black level, and thus enhances the contrast ratio of the display image. This is for the following reason.

One of the factors in increasing the luminance of black level is the light emission caused by an initializing discharge. However, in a selective initializing operation, no discharge occurs in the discharge cells having undergone no sustain discharge in the immediately preceding subfield. Thus, the selective initializing operation substantially does not affect the brightness of luminance of black level. However, in a forced initializing operation, an initializing discharge occurs in the discharge cells regardless of the operation in the immediately preceding subfield. Thus, the forced initializing operation affects the brightness of luminance of black level. That is, as the frequency of forced initializing operations increases, the luminance of black level increases. Thus, reducing the frequency of forced initializing operations in each discharge cell can reduce the luminance of black level in the display image and enhance the contrast.

In this exemplary embodiment, a first field and a second field are alternately generated. The first field includes a specified-cell initializing subfield where a forced initializing operation is performed on the discharge cells formed on scan electrodes 22 in odd-numbered positions. The second field includes a specified-cell initializing subfield where a forced initializing operation is performed on the discharge cells on scan electrodes 22 in even-numbered positions.

With this structure, a forced initializing operation can be performed once in two fields. Thus, in this structure, the frequency of forced initializing operations performed on each discharge can be made a half of that in the structure where a forced initializing operation is performed on all the discharge cells in every field. Therefore, this structure can reduce the luminance of black level and enhance the contrast ratio of the image displayed on panel 10.

Further, since an initializing discharge occurs in all the discharge cells at least once in two fields, the address operation after the forced initializing operation can be stabilized.

However, in this exemplary embodiment, the number of subfields forming one field, the frequency of forced initializing operations, the luminance weight of each subfield or the like is not limited to the above numerical values. The subfield structure may be switched in response to an image signal, for example.

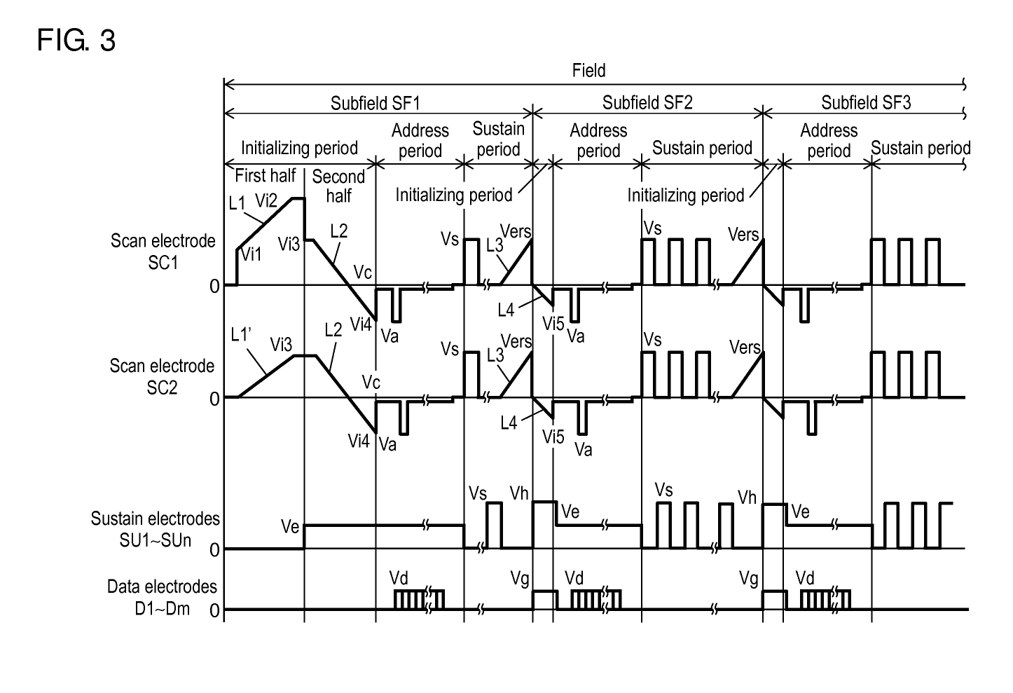

FIG. 3 is a chart schematically showing driving voltage waveforms applied to the respective electrodes of panel 10 for use in the plasma display apparatus in accordance with the exemplary embodiment of the present invention.

FIG. 3 shows driving voltage waveforms applied to the following electrodes: scan electrode SC1 to undergo an address operation first in the address periods; scan electrode SC2 to undergo an address operation second in the address periods; sustain electrode SU1-sustain electrode SUn; and data electrode D1-data electrode Dm. Scan electrode SCi, sustain electrode SUi, and data electrode Dk in the following description show the electrodes selected among the respective electrodes based on image data (data representing light emission and no light emission in each subfield).

FIG. 3 shows subfield SF1, i.e. a specified-cell initializing subfield, and subfield SF2 and subfield SF3, i.e. selective initializing subfields. The waveform shape of the driving voltage applied to scan electrodes 22 in the initializing period of subfield SF1 is different from that in subfield SF2-subfield SF10.

Although subfield SF4 and subfields thereafter are not shown, the respective subfields except subfield SF1 are selective initializing subfields and thus substantially the same driving voltage waveforms except for the number of sustain pulses are generated in the respective periods of these subfields. FIG. 3 shows a first field where a forced initializing operation is performed on the discharge cells on scan electrode SC1 and only a selective initializing operation instead of a forced initializing operation is performed on the discharge cells on scan electrode SC2. In subfield SF1 of a first field and subfield SF1 of a second field, only scan electrodes 22 to be applied with a forced initializing waveform in the initializing periods are different. In the other subfields, the respective discharge cells are applied with substantially the same driving voltage waveforms.

First, subfield SF1, a specified-cell initializing subfield, is described.

In this exemplary embodiment, as described above, the following operations are performed in a specified-cell initializing subfield (subfield SF1) of a first field. A forced initializing waveform for performing a forced initializing operation is applied to scan electrodes SC(1+2×N) in the odd-numbered positions from the top, i.e. in the (1+2×N)-th positions (N being integers equal to or greater than 0). A selective initializing waveform for performing a selective initializing operation is applied to scan electrodes SC(2+2×N) in the even-numbered positions from the top, i.e. in the (2+2×N)-th positions. FIG. 3 shows scan electrode SC1 as an example of odd-numbered scan electrodes SC(1+2×N) and scan electrode SC2 as an example of even-numbered scan electrodes SC(2+2×N).

In the first half of the initializing period of subfield SF1 where a specified-cell initializing operation is performed, voltage 0 (V) is applied to each of data electrode D1-data electrode Dm and sustain electrode SU1-sustain electrode SUn. Scan electrodes SC(1+2×N) in the odd-numbered positions (e.g. scan electrode SC1) are applied with voltage 0 (V) and then voltage Vi1. Thereafter, these scan electrodes are applied with a ramp waveform voltage (hereinafter referred to as “up-ramp voltage L1”) that rises from voltage Vi1 toward voltage Vi2 gently (with a gradient of approximately 1.3 V/μsec, for example). Voltage Vi1 is set to a voltage lower than a discharge start voltage with respect to sustain electrodes SU(1+2×N), and voltage Vi2 is set to a voltage exceeding the discharge start voltage with respect to sustain electrodes SU(1+2×N).

While up-ramp voltage L1 is rising, a weak initializing discharge continuously occurs between scan electrodes SC(1+2×N) and sustain electrodes SU(1+2×N), and between scan electrodes SC(1+2×N) and data electrode D1-data electrode Dm in the respective discharge cells. Then, negative wall voltage accumulates on scan electrodes SC(1+2×N); positive wall voltage accumulates on data electrode D1-data electrode Dm intersecting scan electrodes SC(1+2×N), and sustain electrodes SU(1+2×N). This discharge also generates priming that shortens the discharge delay time of an address discharge (the length of time after the voltage applied to a discharge cell exceeds the discharge start voltage and before a discharge occurs in the discharge cell). This wall voltage on the electrodes means the voltage generated by the wall charge that is accumulated on the dielectric layers covering the electrodes, the protective layer, the phosphor layers, or the like.

In the second half of the initializing period of subfield SF1, positive voltage Ve is applied to sustain electrode SU1-sustain electrode SUn and voltage 0 (V) is applied to data electrode D1-data electrode Dm. Scan electrodes SC(1+2×N) are applied with a down-ramp waveform voltage (hereinafter referred to as “down-ramp voltage L2”) that falls from voltage Vi3 toward negative voltage Vi4 gently (with a gradient of approximately −1.5 V/μsec, for example). Voltage Vi3 is set to a voltage lower than the discharge start voltage with respect to sustain electrodes SU(1+2×N), and voltage Vi4 is set to a voltage exceeding the discharge start voltage with respect to sustain electrodes SU(1+2×N).

While down-ramp voltage L2 is applied to scan electrodes SC(1+2×N), a weak initializing discharge occurs between scan electrodes SC(1+2×N) and sustain electrodes SU(1+2×N), and between scan electrodes SC(1+2×N) and data electrode D1-data electrode Dm in the respective discharge cells. This weak discharge adjusts the negative wall voltage on scan electrodes SC(1+2×N), the positive wall voltage on sustain electrodes SU(1+2×N), and the positive wall voltage on data electrode D1-data electrode Dm intersecting scan electrodes SC(1+2×N) to voltages suitable for the address operation in the address period. Further, this discharge generates priming that shortens the discharge delay time of the address discharge.

The above waveform is the forced initializing waveform for causing an initializing discharge in the discharge cells regardless of the operation in the immediately preceding subfield. The operation of applying the forced initializing waveform to scan electrodes 22 is the forced initializing operation.

In contrast, in the first half of the initializing period of subfield SF1, scan electrodes SC(2+2×N) in the even-numbered positions from the top are not applied with voltage Vi1. Instead, these scan electrodes are applied with up-ramp voltage L1′, which gently rises from voltage 0 (V) toward voltage Vi3. This up-ramp voltage L1′ is a voltage waveform that continues to rise for a period equal to that of up-ramp voltage L1 with a gradient equal to that of up-ramp voltage L1. Therefore, voltage Vi3 is equal to a voltage obtained by subtracting voltage Vi1 from voltage Vi2. At this time, each voltage and up-ramp voltage L1′ are set such that voltage Vi3 is lower than the discharge start voltage with respect to sustain electrodes SU(2+2×N). With this setting, substantially no discharge occurs in the discharge cells applied with up-ramp voltage L1′.

In the second half of the initializing period of subfield SF1, down-ramp voltage L2 is applied to scan electrodes SC(2+2×N), in a manner similar to that of scan electrodes SC(1+2×N).

While this down-ramp voltage L2 is applied to scan electrodes SC(2+2×N), a weak initializing discharge occurs in the discharge cells having undergone a sustain discharge in the sustain period of the immediately preceding subfield (subfield SF10 not shown in FIG. 3). This initializing discharge adjusts the negative wall voltage on scan electrodes 22, the positive wall voltage on sustain electrodes 23, and the positive wall voltage on data electrodes 23 to voltages suitable for the address operation in the address period. Thus, the wall voltages in the discharge cells are adjusted to wall voltages suitable for the address operation. Further, this discharge generates priming that shortens the discharge delay time in the address discharge.

In contrast, in the discharge cells having undergone no sustain discharge in the sustain period of the immediately preceding subfield (subfield SF10), no initializing discharge occurs, and the previous wall voltage is maintained.

In this manner, in subfield SF1 of a first field, the initializing operation in the discharge cells on scan electrodes SC(2+2×N) in the even-numbered positions from the top is a selective initializing operation for selectively causing an initializing discharge in the discharge cells having undergone an address operation in the address period of the immediately preceding subfield.

The above voltage waveform is the selective initializing waveform to be applied to scan electrodes SC(2+2×N) in subfield SF1.

Although a detailed description is omitted, in a specified-cell initializing subfield (subfield SF1) of a second field, the following operations are performed. In the initializing period, a forced initializing waveform for performing a forced initializing operation is applied to scan electrodes SC(2+2×N) in the even-numbered positions from the top, i.e. in the (2+2×N)-th positions. A selective initializing waveform for performing a selective initializing operation is applied to scan electrodes SC(1+2×N) in the odd-numbered positions from the top, i.e. in the (1+2×N)-th positions.

In this manner, the specified-cell initializing operation in the initializing period of a specified-cell initializing subfield (subfield SF1) is completed. In the initializing period of the specified-cell initializing subfield, some discharge cells undergo a forced initializing operation and the other discharge cells undergo a selective initializing operation.

In the address period of subfield SF1, voltage Ve is applied to sustain electrode SU1-sustain electrode SUn, voltage 0 (V) is applied to data electrode D1-data electrode Dm, and voltage Vc is applied to scan electrode SC1-scan electrode SCn.

Next, a negative scan pulse at negative voltage Va is applied to scan electrode SC1 in the first position from the top (in the first row). Further, a positive address pulse at positive voltage Vd is applied to data electrode Dk of a discharge cell to be lit in the first row among data electrode D1-data electrode Dm.

In the discharge cell where data electrode Dk applied with address pulse voltage Vd intersects scan electrode SC1 applied with scan pulse voltage Va, the voltage difference between data electrode Dk and scan electrode SC1 exceeds a discharge start voltage, and a discharge occurs between data electrode Dk and scan electrode SC1.

Since voltage Ve is applied to sustain electrode SU1-sustain electrode SUn, the discharge between data electrode Dk and scan electrode SC1 induces a discharge between the areas of sustain electrode SU1 and scan electrode SC1 intersecting data electrode Dk. Thus, an address discharge occurs in the discharge cell applied with scan pulse voltage Va and address pulse voltage Vd at the same time (the discharge cell to be lit).

In the discharge cell where the address discharge has occurred, positive wall voltage accumulates on scan electrode SC1 and negative wall voltage accumulates on sustain electrode SU1 and data electrode Dk.

In this manner, an address operation in the discharge cells in the first row is completed. In contrast, in the discharge cells applied with no address pulse, no address discharge occurs and the wall voltage after the completion of the initializing period is maintained.

Next, a scan pulse at voltage Va is applied to scan electrode SC2 in the second position from the top (in the second row), and an address pulse at voltage Vd is applied to data electrode Dk corresponding to a discharge cell to be lit in the second row. Then, an address discharge occurs in the discharge cells in the second row applied with a scan pulse and an address pulse at the same time. Thus, an address operation is performed on the discharge cells in the second row.

The similar address operation is performed on the discharge cells on scan electrode SC3, scan electrode SC4, . . . , scan electrode SCn in this order until the operation reaches the discharge cells in the n-th row. Thus, the address period of subfield SF1 is completed. In this manner, in the address period, an address discharge is caused selectively in the discharge cells to be lit so as to form wall charge for a sustain discharge in the discharge cells.

Voltage Ve applied to sustain electrode SU1-sustain electrode SUn in the second half of the initializing period and voltage Ve applied to sustain electrode SU1-sustain electrode SUn in the address period may have different voltage values.

In the sustain period of subfield SF1, first, voltage 0 (V) is applied to sustain electrode SU1-sustain electrode SUn and a sustain pulse at positive voltage Vs is applied to scan electrode SC1-scan electrode SCn.

With the application of this sustain pulse, in a discharge cell having undergone an address discharge, the voltage difference between scan electrode SCi and sustain electrode SUi exceeds the discharge start voltage, and a sustain discharge occurs. Ultraviolet rays generated by this discharge cause phosphor layer 35 to emit light. With this discharge, negative wall voltage accumulates on scan electrode SCi and positive wall voltage accumulates on sustain electrode SUi. Positive wall voltage also accumulates on data electrode Dk. However, in the discharge cells having undergone no address discharge in the address period, no sustain discharge occurs.

Subsequently, voltage 0 (V) is applied to scan electrode SC1-scan electrode SCn and a sustain pulse at voltage Vs is applied to sustain electrode SU1-sustain electrode SUn. In the discharge cells having undergone the sustain discharge immediately before this voltage application, a sustain discharge occurs again. Negative wall voltage accumulates on sustain electrode SUi and positive wall voltage accumulates on scan electrode SCi.

Similarly, sustain pulses equal in number to the luminance weight multiplied by a predetermined luminance magnification are applied alternately to scan electrode SC1-scan electrode SCn and sustain electrode SU1-sustain electrode SUn. Thus, in the discharge cells having undergone the address discharge in the address period, sustain discharges corresponding in number to the luminance weight occur and light emission occurs at luminances corresponding to the luminance weight.

After the sustain pulses have been generated in the sustain period (at the end of the sustain period), the following operation is performed. While sustain electrode SU1-sustain electrode SUn and data electrode D1-data electrode Dm are applied with voltage 0 (V), scan electrode SC1-scan electrode SCn are applied with a ramp waveform voltage (hereinafter referred to as “erasing ramp voltage L3”) that rises from voltage 0 (V) to voltage Vers gently (with a gradient of approximately 10 V/μsec, for example).

Voltage Vers is set so as to exceed a discharge start voltage. Thereby, while erasing ramp voltage L3 applied to scan electrode SC1-scan electrode SCn is rising above the discharge start voltage, a weak discharge (erasing discharge) continuously occurs between sustain electrode SUi and scan electrode SCi in a discharge cell having undergone a sustain discharge.

The charged particles generated by this weak discharge accumulate on sustain electrode SUi and scan electrode SCi as wall charge so as to reduce the voltage difference between sustain electrode SUi and scan electrode SCi. This reduces the wall voltage on scan electrode SCi and the wall voltage on sustain electrode SUi while the positive wall voltage is left on data electrode Dk. Thus, unnecessary wall charge in the discharge cell is erased.

After the voltage applied to scan electrode SC1-scan electrode SCn has reached voltage Vers, the voltage applied to scan electrode SC1-scan electrode SCn is lowered to voltage 0 (V). Thus, the sustain operation in the sustain period of subfield SF1 is completed.

In this manner, subfield SF1 is completed.

Next, a description is provided for a selective initializing subfield, using subfield SF2 as an example.

In the initializing period of subfield SF2, positive voltage Vg is applied to data electrode D1-data electrode Dm, and voltage Vh, which is higher than voltage Ve, is applied to sustain electrode SU1-sustain electrode SUn.

Scan electrode SC1-scan electrode SCn are applied with down-ramp voltage L4, which falls from a voltage (e.g. voltage 0 (V)) lower than the discharge start voltage toward negative voltage Vi5, with a gradient equal to that of down-ramp voltage L2. Voltage Vi5 is set to a voltage exceeding the discharge start voltage.

This voltage Vi5 is controlled based on the calculation result in data load detection circuit 37 to be described later. This control is detailed later.

While down-ramp voltage L4 is applied to scan electrode SC1-scan electrode SCn, a weak initializing discharge occurs in the discharge cells having undergone a sustain discharge in the sustain period of the immediately preceding subfield (subfield SF1 in FIG. 3).

This initializing discharge reduces the wall voltage on scan electrode SCi and the wall voltage on sustain electrode SUi. This initializing discharge also discharges excess part of the wall voltage accumulated on data electrode Dk. Thus, the wall voltages in the discharge cell are adjusted to wall voltages suitable for the address operation.

In contrast, in the discharge cells having undergone no sustain discharge in the sustain period of the immediately preceding subfield (subfield SF1), no initializing discharge occurs, and the previous wall voltage is maintained.

The above waveforms are the selective initializing waveforms for causing an initializing discharge selectively in the discharge cells having undergone an address operation in the address period of the immediately preceding subfield. The operation of applying the selective initializing waveforms to scan electrodes 22 is the selective initializing operation.

Thus, a selective initializing operation in the initializing period of subfield SF2, i.e. a selective initializing subfield, is completed.

The waveform shape of the selective initializing waveforms generated in the initializing period of subfield SF1 is different from that of the selective initializing waveforms generated in the initializing period of subfield SF2. However, in the selective initializing waveforms generated in the initializing period of subfield SF1, no discharge occurs in the first half, and the operation in the second half is substantially equal to the selective initializing operation in the initializing period of subfield SF2. Thus, in this exemplary embodiment, the initializing waveform that includes up-ramp voltage L1′ and down-ramp voltage L2 generated in the initializing period of subfield SF1 is defined as a selective initializing waveform.

In the address period of subfield SF2, the respective electrodes are applied with driving voltage waveforms same as those in the address period of subfield SF1. Also in the subsequent sustain period, similarly to the sustain period of subfield SF1, sustain pulses corresponding in number to the luminance weight are applied alternately to scan electrode SC1-scan electrode SCn and sustain electrode SC1-sustain electrode SCn.

In subfield SF3 and subfields thereafter, the respective electrodes are applied with the driving voltage waveforms same as those in subfield SF2 except for the number of sustain pulses generated in the sustain period.

The above description has outlined the driving voltage waveforms applied to the respective electrodes of panel 10 in this exemplary embodiment.

In this exemplary embodiment, examples of values of voltage applied to the respective electrodes are as follows: voltage Vi1=150 (V); voltage Vi2=350 (V); voltage Vi3=200 (V); voltage Vi4=−170 (V); voltage Vi5=−110 (V); voltage Vc=−50 (V); voltage Va=−200 (V); voltage Vs=200 (V); voltage Vers=200 (V); voltage Ve=170 (V); voltage Vd=60 (V); voltage Vg=60 (V); and voltage Vh=200 (V).

However, the above voltage values and the specific numerical values of gradients are only examples. In the present invention, the respective voltage values and gradients are not limited to the above numerical values. Preferably, the respective voltage values, gradients, or the like are set optimally for the discharge characteristics of the panel, the specifications of the plasma display apparatus, or the like.

In the example described in this exemplary embodiment, subfield SF1 is a specified-cell initializing subfield where a forced initializing operation is performed, and the other subfields (subfield SF2-subfield SF10) are selective initializing subfields where a selective initializing operation is performed. However, the present invention is not limited to this structure. For instance, subfield SF1 may be set to a selective initializing subfield or a plurality of subfields may be set to specified-cell initializing subfields.

Next, a description is provided for a configuration of the plasma display apparatus in this exemplary embodiment.

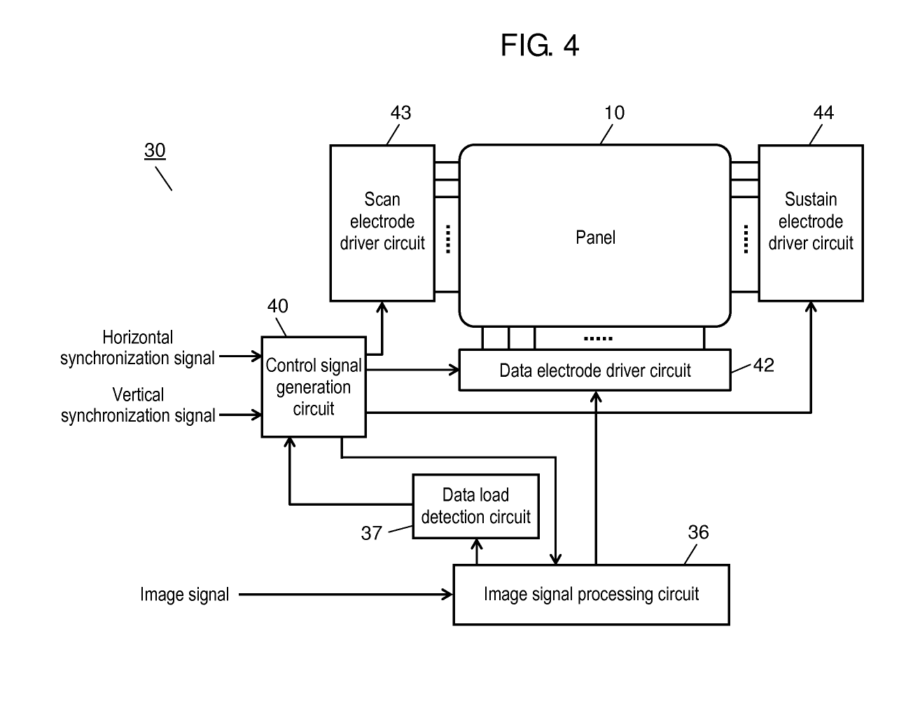

FIG. 4 is a diagram schematically showing an example of circuit blocks forming plasma display apparatus 30 in accordance with the exemplary embodiment of the present invention.

Plasma display apparatus 30 includes panel 10 and driver circuits for driving panel 10. The driver circuits include image signal processing circuit 36, data load detection circuit 37, data electrode driver circuit 42, scan electrode driver circuit 43, sustain electrode driver circuit 44, control signal generation circuit 40, and electric power supply circuits (not shown) for supplying electric power necessary for each circuit block.

The image signals input to image signal processing circuit 36 are a red image signal, a green image signal, and a blue image signal. Based on the red image signal, the green image signal, and the blue image signal, image signal processing circuit 36 sets red, green, and blue gradation values (gradation values represented in one field) for the respective discharge cells. When input image signals include a luminance signal (Y signal) and a chroma signal (C signal, R-Y signal and B-Y signal, u signal and v signal, or the like), image signal processing circuit 36 calculates a red image signal, a green image signal, and a blue image signal based on the luminance signal and the chroma signal, and thereafter sets red, green, and blue gradation values for the respective discharge cells. Then, the image signal processing circuit converts the red, green, and blue gradation values set for the respective discharge cells into image data representing light emission and no light emission in each subfield (data where light emission and no light emission correspond to the digital signals “1” and “0”, respectively). That is, image signal processing circuit 36 converts a red image signal, a green image signal, and a blue image signal into red image data, green image data, and blue image data, respectively, and outputs the converted data.

Based on the lighting pattern of the respective discharge cells in each subfield that is shown in image data supplied from image signal processing circuit 36, data load detection circuit 37 detects a pattern of address pulses generated in data electrode driver circuit 42. Next, the data load detection circuit calculates the magnitude of the load (hereinafter “load value”) when data electrode driver circuit 42 applies an address pulse to each of data electrode D1-data electrode Dm. Then, based on the calculation result, data load detection circuit 37 estimates a voltage drop in the power supply voltage supplied from the electric power supply circuit to data electrode driver circuit 42, and outputs the estimation result to control signal generation circuit 40. The operation of data load detection circuit 37 is detailed later.

Control signal generation circuit 40 generates various control signals for controlling the operation of each circuit block in response to a horizontal synchronization signal, a vertical synchronization signal, and the output of data load detection circuit 37. Then, the control signal generation circuit supplies the generated control signals to each circuit block (data electrode driver circuit 42, scan electrode driver circuit 43, sustain electrode driver circuit 44, image signal processing circuit 36, or the like). Control signal generation circuit 40 controls the minimum voltage of a selective initializing waveform based on the signal output from data load detection circuit 37. This control is detailed later.

Scan electrode driver circuit 43 has an initializing waveform generation circuit, a sustain pulse generation circuit, and a scan pulse generation circuit (not shown in FIG. 4). The scan electrode driver circuit generates driving voltage waveforms in response to control signals supplied from control signal generation circuit 40, and applies the waveforms to each of scan electrode SC1-scan electrode SCn. In response to a control signal, the initializing waveform generation circuit generates a forced initializing waveform and a selective initializing waveform to be applied to scan electrode SC1-scan electrode SCn in the initializing periods. In response to a control signal, the sustain pulse generation circuit generates sustain pulses to be applied to scan electrode SC1-scan electrode SCn in the sustain periods. The scan pulse generation circuit has a plurality of scan electrode driver ICs (scan ICs) and generates scan pulses to be applied to scan electrode SC1-scan electrode SCn in the address periods in response to a control signal. Scan electrode driver circuit 43 generates a selective initializing waveform at a minimum voltage in response to the control signal output from control signal generation circuit 40.

Sustain electrode driver circuit 44 has a sustain pulse generation circuit, a circuit for generating voltage Ve, and a circuit for generating voltage Vh (not shown in FIG. 4). The sustain electrode driver circuit generates driving voltage waveforms in response to control signals supplied from control signal generation circuit 40, and applies the waveforms to each of sustain electrode SU1-sustain electrode SUn. In the sustain periods, the sustain electrode driver circuit generates sustain pulses in response to a control signal and applies the sustain pulses to sustain electrode SU1-sustain electrode SUn. The sustain electrode driver circuit generates voltage Ve or voltage Vh in response to control signals in the initializing periods, generates voltage Ve in response to control signals in the address periods, and applies the voltages to sustain electrode SU1-sustain electrode SUn.

Data electrode driver circuit 42 generates an address pulse corresponding to each of data electrode D1-data electrode Dm, in response to the image data of respective colors output from image signal processing circuit 36 and control signals supplied from control signal generation circuit 40. Data electrode driver circuit 42 applies the address pulse to each of data electrode D1-data electrode Dm in the address periods. In the selective initializing periods, the data electrode driver circuit generates voltage Vg in response to a control signal and applies the voltage to data electrode D1-data electrode Dm.

Next, the details and operation of scan electrode driver circuit 43 are described.

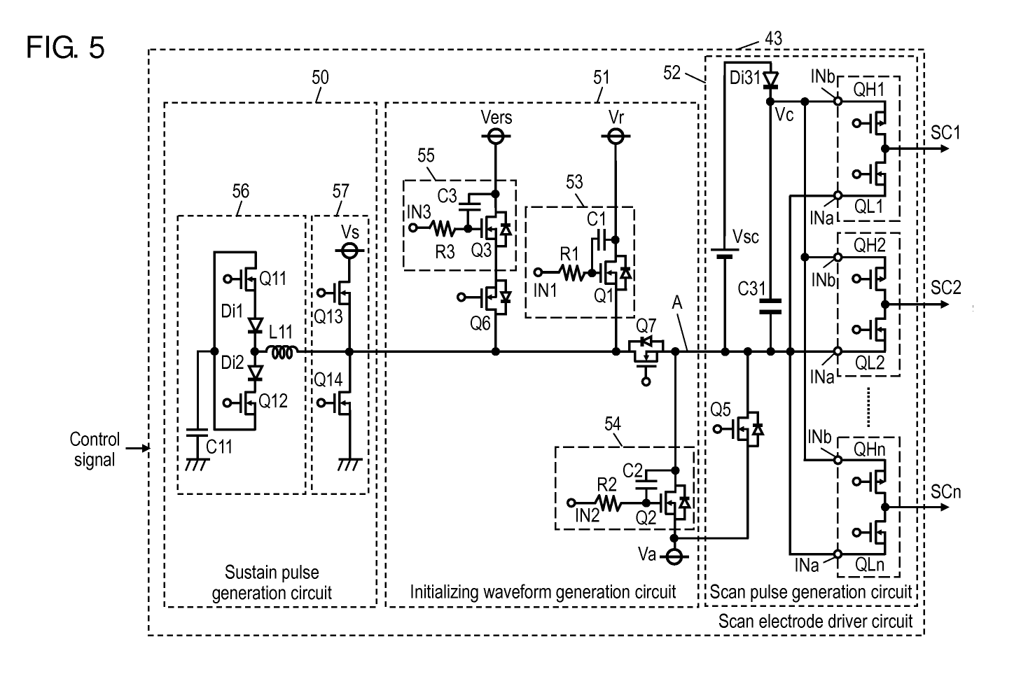

FIG. 5 is a circuit diagram schematically showing a configuration example of scan electrode driver circuit 43 in accordance with the exemplary embodiment of the present invention. Scan electrode driver circuit 43 has the following elements:

sustain pulse generation circuit 50 for generating sustain pulses;

initializing waveform generation circuit 51 for generating initializing waveforms; and

scan pulse generation circuit 52 for generating scan pulses.

Each output terminal of scan pulse generation circuit 52 is connected to corresponding one of scan electrode SC1-scan electrode SCn of panel 10.

In this exemplary embodiment, the voltage input to scan pulse generation circuit 52 is denoted as “reference electric potential A”. In the following description, the operation of turning on a switching element is denoted as “ON”, and the operation of turning off a switching element is denoted as “OFF”. A signal for setting a switching element to ON is denoted as “Hi”, and a signal for setting a switching element to OFF is denoted as “Lo”. In FIG. 5, the details of the paths for the control signals (supplied from control signal generation circuit 40) input to each circuit are omitted.

FIG. 5 shows a separation circuit including switching element Q7 for electrically separating sustain pulse generation circuit 50, a circuit based on voltage Vr (e.g. Miller integration circuit 53), and a circuit based on voltage Vers (e.g. Miller integration circuit 55) from a circuit based on negative voltage Va (e.g. Miller integration circuit 54) while the latter circuit is operated. The diagram also shows a separation circuit including switching element Q6 for electrically separating a circuit based on voltage Vers (e.g. Miller integration circuit 55), which is lower than voltage Vr, from a circuit based on voltage Vr (e.g. Miller integration circuit 53) while the latter circuit is operated.

Sustain pulse generation circuit 50 has power recovery circuit 56 and clamp circuit 57.

Power recovery circuit 56 has power recovery capacitor C11, switching element Q11, switching element Q12, blocking diode Di1, diode Di2, and resonance inductor L11. Power recovery capacitor C11 has a capacity sufficiently larger than interelectrode capacitance Cp, and is charged to approximately Vs/2, i.e. a half of voltage value Vs, so as to serve as the electric power supply of power recovery circuit 56.

Clamp circuit 57 has switching element Q13 for clamping scan electrode SC1-scan electrode SCn to voltage Vs, and switching element Q14 for clamping scan electrode SC1-scan electrode SCn to voltage 0 (V). The sustain pulse generation circuit generates sustain pulses by switching each switching element in response to control signals output from control signal generation circuit 40.

For instance, when a sustain pulse is caused to rise, resonance is produced between interelectrode capacitance Cp and inductor L11 by setting switching element Q11 to ON. Thereby, the electric power stored in power recovery capacitor C11 is supplied, through switching element Q11, diode Di1, and inductor L11, to scan electrode SC1-scan electrode SCn. At the time when the voltage of scan electrode SC1-scan electrode SCn approaches voltage Vs, switching element Q13 is set to ON so as to clamp scan electrode SC1-scan electrode SCn to voltage Vs.

When a sustain pulse is caused to fall, resonance is produced between interelectrode capacitance Cp and inductor L11 by setting switching element Q12 to ON. Thereby, the electric power in interelectrode capacitance Cp is recovered, through inductor L11, diode Dig, and switching element Q12, to power recovery capacitor C11. At the time when the voltage of scan electrode SC1-scan electrode SCn approaches voltage 0 (V), switching element Q14 is set to ON so as to clamp scan electrode SC1-scan electrode SCn to voltage 0 (V).

Initializing waveform generation circuit 51 has Miller integration circuit 53, Miller integration circuit 54, and Miller integration circuit 55. FIG. 5 shows the input terminal of Miller integration circuit 53 as input terminal IN1, the input terminal of Miller integration circuit 54 as input terminal IN2, and the input terminal of Miller integration circuit 55 as input terminal IN3. Each of Miller integration circuit 53 and Miller integration circuit 55 generates a rising ramp voltage. Miller integration circuit 54 generates a falling ramp voltage.

Miller integration circuit 53 has switching element Q1, capacitor C1, and resistor R1. In the initializing operation, this Miller integration circuit generates up-ramp voltage L1′ by causing reference electric potential A of scan electrode driver circuit 43 to rise to voltage V13 gently (with a gradient of 1.3 V/μsec, for example) in a ramp form.

Miller integration circuit 55 has switching element Q3, capacitor C3, and resistor R3. At the end of each sustain period, this Miller integration circuit generates erasing ramp voltage L3 by causing reference electric potential A to rise to voltage Vers with a gradient (e.g. 10 V/μsec) steeper than that of up-ramp voltage L1′.

Miller integration circuit 54 has switching element Q2, capacitor C2, and resistor R2. In the initializing operation, this Miller integration circuit generates down-ramp voltage L2 by causing reference electric potential A to fall to voltage Vi4 gently (with a gradient of −1.5 V/μsec, for example) in a ramp form. This Miller integration circuit also generates down-ramp voltage L4 by causing reference electric potential A to fall to voltage Vi5 gently (with a gradient of −1.5 V/μsec, for example) in a ramp form.

Voltage Vi5 changes in response to a control signal supplied from control signal generation circuit 40. Voltage Vi5 can be set to any voltage by controlling the time during which Miller integration circuit 54 is operated.

Scan pulse generation circuit 52 has switching element QH1-switching element QHn and switching element QL1-switching element QLn for applying a scan pulse to n scan electrode SC1-scan electrode SCn, respectively. One terminal of switching element QHj (j=1-n) is interconnected to one terminal of switching element QLj. The interconnected part forms an output terminal of scan pulse generation circuit 52 and is connected to scan electrode SCj. The other terminal of switching element QHj is input terminal INb; the other terminal of switching element QLj is input terminal INa.

Switching element QH1-switching element QHn and switching element QL1-switching element QLn are grouped in a plurality of outputs and formed into ICs. These ICs are scan ICs.

Scan pulse generation circuit 52 includes the following elements:

switching element Q5 for connecting reference electric potential A to negative voltage Va in the address periods;

electric power supply VSC for generating voltage Vsc such that voltage Vsc is superimposed on reference electric potential A; and

diode Di31 and capacitor C31 for applying, to input terminal INb, voltage Vc, which is obtained by superimposing voltage Vsc on reference electric potential A.

Voltage Vc is input to input terminal INb of each of switching element QH1-switching element QHn; reference electric potential A is input to input terminal INa of each of switching element QL1-switching element QLn.

In scan pulse generation circuit 52 thus configured, in the address periods, switching element Q5 is set to ON so as to make reference electric potential A equal to negative voltage Va, so that negative voltage Va is input to input terminal INa. Voltage Vc, i.e. voltage Va+voltage Vsc, is applied to input terminal INb. Then, based on subfield data, the following operations are performed. To scan electrode SCi to be applied with a scan pulse, negative scan pulse voltage Va is applied via switching element QLi by setting switching element QHi to OFF and switching element QLi to ON. To scan electrode SCh to be applied with no scan pulse (h=1-n except i), voltage Va+voltage Vsc (=voltage Vc) is applied via switching element QHh by setting switching element QLh to OFF and switching element QHh to ON.

Scan pulse generation circuit 52 sets switching elements QL(1+2×N) to OFF and switching elements QH(1+2×N) to ON for scan electrodes SC(1+2×N) to be applied with a forced initializing waveform in a specified-cell initializing period. Thereby, up-ramp voltage L1, which is obtained by superimposing voltage Vsc on up-ramp voltage L1′ output from initializing waveform generation circuit 51, is applied to scan electrodes SC(1+2×N) via switching elements QH(1+2×N). For scan electrodes SC(2+2×N) to be applied with a selective initializing waveform in the specified-cell initializing period, the scan pulse generation circuit sets switching elements QH(2+2×N) to OFF and switching elements QL(2+2×N) to ON. Thereby, up-ramp voltage L1′ is applied to scan electrodes SC(2+2×N) via switching elements QL(2+2×N).

Next, data electrode driver circuit 42 is detailed.

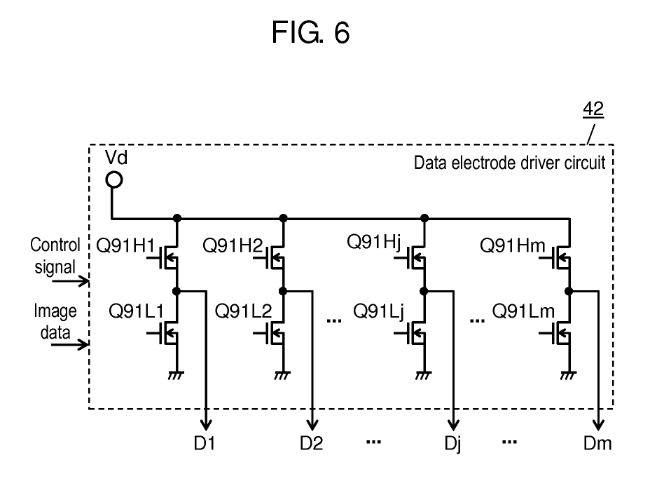

FIG. 6 is a circuit diagram schematically showing a configuration of data electrode driver circuit 42 in accordance with the exemplary embodiment of the present invention.

In FIG. 6, the details of signal paths for control signals input to each circuit (control signals supplied from control signal generation circuit 40 and image data supplied from image signal processing circuit 36) are omitted.

Data electrode driver circuit 42 includes switching element Q91H1-switching element Q91Hm and switching element Q91L1-switching element Q91Lm. In the address periods, based on image data (details of image data being omitted in the diagram), the following operations are performed. When voltage 0 (V) is applied to data electrode Dj, switching element Q91Lj is set to ON and switching element Q91Hj is set to OFF. When voltage Vd is applied to data electrode Dj, switching element Q91Lj is set to OFF and switching element Q91Hj is set to ON.

In the selective initializing periods, based on a control signal supplied from control signal generation circuit 40, voltage Vd (=voltage Vg) is applied to data electrode D1-data electrode Dm by setting switching element Q91L1-switching element Q91Lm to OFF and switching element Q91H1-switching element Q91Hm to ON.

Next, the operation of data load detection circuit 37 is described.

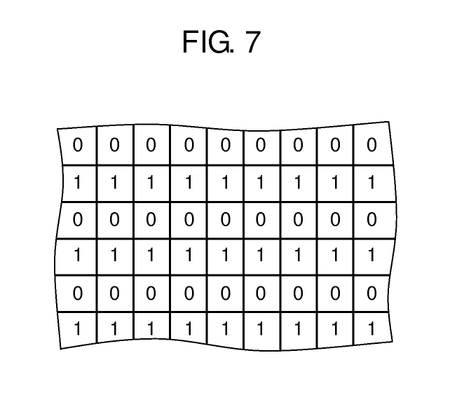

FIG. 7 is a partially enlarged chart of an example of a lighting pattern displayed on panel 10 in plasma display apparatus 30 in accordance with the exemplary embodiment of the present invention.

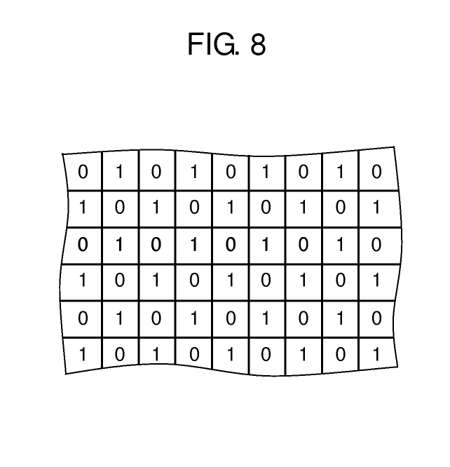

FIG. 8 is a partially enlarged chart of another example of the lighting pattern displayed on panel 10 in plasma display apparatus 30 in accordance with the exemplary embodiment.

In FIG. 7 and FIG. 8, one checker represents one discharge cell. The value “1” in a checker shows that the discharge cell is lit and the value “0” shows that the discharge cell is unlit.

In each of the lighting patterns shown in FIG. 7 and FIG. 8, the light-emitting rate of the discharge cells is approximately 50%. Thus, in each of the lighting patterns of FIG. 7 and FIG. 8, the number of lit discharge cells (hereinafter denoted as “lit cells”) is substantially equal to the number of unlit discharge cells (hereinafter denoted as “unlit cells”). However, the lighting pattern of FIG. 7 is different from the lighting pattern of FIG. 8.

In the lighting pattern of FIG. 7, a lit discharge cell alternates with an unlit discharge cell in the vertical direction (i.e. in the column direction). However, the discharge cells in the horizontal direction (i.e. in the row direction) are all lit or all unlit. This pattern is considered in two discharge cells adjacent to each other. In two discharge cells adjacent in the horizontal direction, both discharge cells are lit or unlit at the same time. In contrast, in two discharge cells adjacent in the vertical direction, one of the discharge cells is lit and the other is unlit. For instance, when a horizontal striped pattern repeated every other row (line) is displayed on panel 10, the respective discharge cells are lit in the lighting pattern of FIG. 7.

When the respective discharge cells are lit in this pattern, this pattern is considered in two data electrodes 22 adjacent to each other. A state where an address pulse is applied to two data electrodes 22 at the same time alternates with a state where no address pulse is applied to the two data electrodes 22. For instance, the case of data electrode Dj−1, data electrode Dj, and data electrode Dj+1 is considered. When an address pulse is applied to data electrode Dj, data electrode Dj−1 and data electrode Dj+1 are also applied with an address pulse. When no address pulse is applied to data electrode Dj, data electrode Dj−1 and data electrode Dj+1 are also applied with no address pulse.

In the lighting pattern of FIG. 8, a lit discharge cell alternates with an unlit discharge cell in the vertical (column) direction. A lit discharge cell alternates with an unlit discharge cell also in the horizontal (row) direction. This pattern is considered in two discharge cells adjacent to each other. In two discharge cells adjacent in the horizontal direction, one of the discharge cells is lit and the other is unlit. Also in two discharge cells adjacent in the vertical direction, one of the discharge cells is lit and the other is unlit. For instance, when a checkered pattern where a lit discharge cell alternates with an unlit discharge cell is displayed on panel 10, the respective discharge cells are lit in the lighting pattern of FIG. 8.

When the respective discharge cells are lit in this lighting pattern, this pattern is considered in two data electrodes 22 adjacent to each other. When an address pulse is applied to one of data electrodes 22, no address pulse is applied to the other of data electrodes 22. When an address pulse is applied to the other of data electrodes 22, no address pulse is applied to the one of data electrodes 22. For instance, the case of data electrode Dj−1, data electrode Dj, and data electrode Dj+1 is considered. When an address pulse is applied to data electrode Dj, data electrode Dj−1 and data electrode Dj+1 are applied with no address pulse. When an address pulse is applied to data electrode Dj−1, no address pulse is applied to data electrode Dj and an address pulse is applied to data electrode Dj+1.

As seen from the side of data electrode driver circuit 42 for driving data electrode D1-data electrode Dm, each of data electrode D1-data electrode Dm is a capacitive load.

When data electrode driver circuit 42 raises the voltage applied to data electrode 22 from voltage 0 (V) to voltage Vd, the data electrode driver circuit needs to charge the capacitance until the voltage of data electrode 22 reaches voltage Vd. Inversely, when the data electrode driver circuit lowers the voltage applied to data electrode 22 from voltage Vd to voltage 0 (V), the data electrode driver circuit needs to discharge the capacitance until the voltage of data electrode 22 reaches voltage 0 (V). That is, data electrode driver circuit 42 needs to charge and discharge the capacitance every time an address pulse is applied to data electrode 22 in the address periods.

The number of times data electrode driver circuit 42 charges and discharges the capacitance is correlated with electric power consumption in data electrode driver circuit 42. As the number of charging and discharging times increases, the electric power consumption in data electrode driver circuit 42 increases. If the electric power consumption in data electrode driver circuit 42 increases and the load in the electric power supply circuit for supplying electric power to data electrode driver circuit 42 increases, the power supply voltage supplied from the electric power supply circuit to data electrode driver circuit 42 can drop.

Each of data electrode D1-data electrode Dm is a capacitive load. Thus, when two data electrodes 22 adjacent to each other are considered, the electric power consumption when the voltage of one of two adjacent data electrodes 22 rises from voltage 0 (V) to voltage Vd changes depending on the state of the other one of data electrodes 22.

Specifically, the electric power consumption in one data electrode 22 whose voltage rises from voltage 0 (V) to voltage Vd is larger when the voltage of the other data electrode 22 is kept at voltage 0 (V) or voltage Vd than when the voltage of the other data electrode 22 rises from voltage 0 (V) to voltage Vd in phase with the one data electrode. The electric power consumption in one data electrode 22 whose voltage rises from voltage 0 (V) to voltage Vd is larger when the voltage of the other electrode 22 falls from voltage Vd to voltage 0 (V) than when the voltage of the other electrode 22 is kept at voltage 0 (V) or voltage Vd.

Thus, the electric power consumption in data electrode driver circuit 42 is larger when the respective discharge cells are lit in the lighting pattern of FIG. 8 than when the respective discharge cells are lit in the lighting pattern of FIG. 7. That is, when the respective discharge cells are lit in the lighting pattern of FIG. 8, the power supply voltage supplied from the electric power supply circuit to data electrode driver circuit 42 is more likely to drop than when the respective discharge cells are lit in the lighting pattern of FIG. 7.

In plasma display apparatus 30 of this exemplary embodiment, as described above, data electrode D1-data electrode Dm are applied with positive voltage Vg in the initializing periods of subfield SF2 and subfields thereafter (selective initializing periods). Scan electrode SC1-scan electrode SCn are applied with down-ramp voltage L4, which falls from voltage 0 (V) to voltage Vi5. Thereby, an initializing discharge occurs in the discharge cells having undergone an address discharge in the immediately preceding subfield. The initializing discharge continues until the voltage difference between data electrode Dk and scan electrode SCi reaches voltage (|Vi5|+|Vg|). For instance, when voltage Vi5=−110 (V) and voltage Vg=60 (V), the voltage applied to the discharge cells gradually increases until the voltage difference between data electrode Dk and scan electrode SCi reaches 170 (V). During this period, the initializing discharge continues.

Thus, in the discharge cells having undergone this initializing discharge (selective initializing discharge), the wall charge is adjusted such that a stable address operation can be performed in the succeeding address period.

At this time, suppose the power supply voltage supplied from the electric power supply circuit to data electrode driver circuit 42 drops and thus the voltage value of voltage Vg applied to data electrodes 32 in a selective initializing period drops. In this case, the maximum potential difference between data electrode Dk and scan electrode SCi becomes smaller than the original voltage (|Vi5|+|Vg|). This small potential difference causes an insufficient initializing discharge and insufficient adjustment of wall charge, and thus can destabilize the address operation in the succeeding address period.

Then, in plasma display apparatus 30 of this exemplary embodiment, a voltage drop in voltage Vg is estimated, and voltage Vi5 is lowered by the estimated voltage drop such that a stable initializing operation can be performed even when voltage Vg drops.

Specifically, in data load detection circuit 37, a magnitude of the load (load value) of a discharge cell (hereinafter denoted as “target cell”) is calculated. This calculation is based on the lighting state (light emission or no light emission) of the target cell, the lighting states of the discharge cells adjacent on the right and left sides of the target cell, and the lighting states of the discharge cells adjacent above and below the target cell.

The lighting state in each discharge cell is determined based on the image data representing light emission or no light emission in each discharge cell in each subfield.

Further, data load detection circuit 37 calculates the total sum (hereinafter denoted as “line total sum”) of the load values of the discharge cells in one line (i.e. m discharge cells) formed on display electrode pair 24 in each row (i.e. in each line).

When the line total sum of load values is relatively small, the electric power consumption in data electrode driver circuit 42 in an address operation performed on the line is relatively small. When the line total sum of load values is relatively large, the electric power consumption in data electrode driver circuit 42 in an address operation on the line is relatively large. Thus, the line total sum of load values can be used as an estimated value of electric power consumption in data electrode driver circuit 42 for each line.

When the numerical value obtained by cumulatively-adding the line total sums of load values over all the lines (hereinafter denoted as “total sum of load values”) is relatively small, the electric power consumption in data electrode driver circuit 42 in the address period is relatively small. When the total sum of load values is relatively large, the electric power consumption in data electrode driver circuit 42 in the address period is relatively large. Thus, the total sum of load values can be used as an estimated value of the electric power consumption in data electrode driver circuit 42 in the address period.

When the electric power consumption in data electrode driver circuit 42 increases and thus the load in the electric power supply circuit for supplying electric power to data electrode driver circuit 42 increases, the power supply voltage supplied from the electric power supply circuit to data electrode driver circuit 42 drops.

Thus, if the electric power consumption in data electrode driver circuit 42 can be estimated, a drop in the power supply voltage supplied from the electric power supply circuit to data electrode driver circuit 42 can be estimated. Therefore, the total sum of load values can be used as an estimated value of a drop in the power supply voltage supplied from the electric power supply circuit to data electrode driver circuit 42.

When the electric power consumption in data electrode driver circuit 42 decreases and thus the load in the electric power supply circuit for supplying electric power to data electrode driver circuit 42 decreases, the power supply voltage supplied from the electric power supply circuit to data electrode driver circuit 42 gradually recovers toward the original voltage.

Then, in order to calculate an estimated value of a voltage drop in the power supply voltage in consideration of the power supply voltage recovered when the electric power consumption of data electrode driver circuit 42 is small, data load detection circuit 37 of this exemplary embodiment subtracts a “recovery value” from the total sum of load values in a constant cycle. This cycle is equal to the cycle of an address operation, for example. Thus, in each address period, the line total sums are cumulatively-added every line and thus the total sum of load values gradually increases, but a recovery value is subtracted from the total sum of load values every line.

For instance, when some consecutive lines at the end of an address period have line total sums of “0”, a “recovery value” is subtracted from the total sum of load values every line and thus the total sum of load values gradually decreases.

In this exemplary embodiment, the minimum value of the total sum of load values is set to “0”. Thus, even if some consecutive lines at the start of an address period have total sums of “0” and thus the total sum of load values is “0” during that period, subtraction of “recovery values” does not make the total sum of load values a negative numerical value.

With this operation, plasma display apparatus 30 can estimate the electric power consumption in data electrode driver circuit 42 in the address period of the subfield, and estimate a voltage drop in the power supply voltage supplied from the electric power supply circuit to data electrode driver circuit 42 at the completion of the address period of the subfield.

As described above, when the electric power consumption in data electrode driver circuit 42 decreases, the power supply voltage supplied from the electric power supply circuit to data electrode driver circuit 42 gradually recovers toward the original voltage. Since data electrodes 32 are kept at voltage 0 (V) in the sustain period, the electric power consumption in data electrode driver circuit 42 is extremely small, and the power supply voltage supplied from the electric power supply circuit to data electrode driver circuit 42 gradually recovers toward the original voltage.

Thus, in this exemplary embodiment, even when the operation of cumulatively-adding line total sums into the total sum of load values is completed at the completion of the address period, the operation of subtracting recovery values from the total sum of load values in a constant cycle is continued in the succeeding sustain period.

Therefore, a voltage drop in the power supply voltage supplied from the electric power supply circuit to data electrode driver circuit 42 immediately before the initializing period can be estimated, based on the total sum of load values immediately before the initializing period. That is, the total sum of load values immediately before the selective initializing period can be used as an estimated value of a voltage drop in voltage Vg, which is applied to data electrodes 32 by data electrode driver circuit 42 in the selective initializing period.

In this manner, in plasma display apparatus 30 of this exemplary embodiment, data load detection circuit 37 calculates a line total sum of load values for each line and cumulatively-adds the line total sums so as to obtain the total sum of load values. Further, the data load detection circuit subtracts a recovery value from the total sum of load values in a constant cycle. Then, based on the total sum of load values immediately before each initializing period, the data load detection circuit estimates a voltage drop in voltage Vg, which is applied to data electrodes 32 by data electrode driver circuit 42 in the selective initializing period.

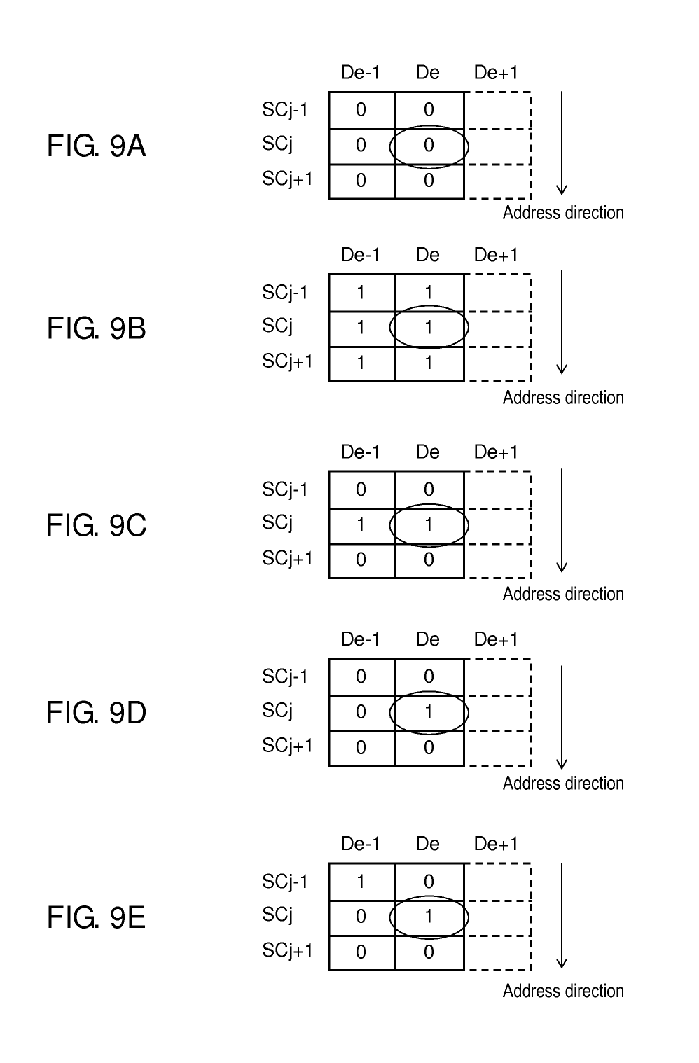

Next, a description is provided for a method for calculating the load value of a target pixel, with reference to FIG. 9A through FIG. 9E.

FIG. 9A is a chart schematically showing an example of a lighting pattern of discharge cells adjacent to each other in plasma display apparatus 30 in accordance with the exemplary embodiment of the present invention.

FIG. 9B is a chart schematically showing another example of the lighting pattern of the discharge cells adjacent to each other in plasma display apparatus 30 in accordance with the exemplary embodiment.

FIG. 9C is a chart schematically showing still another example of the lighting pattern of the discharge cells adjacent to each other in plasma display apparatus 30 in accordance with the exemplary embodiment.

FIG. 9D is a chart schematically showing yet another example of the lighting pattern of the discharge cells adjacent to each other in plasma display apparatus 30 in accordance with the exemplary embodiment.

FIG. 9E is a chart schematically showing still another example of the lighting pattern of the discharge cells adjacent to each other in plasma display apparatus 30 in accordance with the exemplary embodiment.

In FIG. 9A through FIG. 9E, one checker represents one discharge cell. FIG. 9A through FIG. 9E show six discharge cells formed in the part where three scan electrodes 22 consecutive in the vertical (column) direction (scan electrode SCj−1, scan electrode SCj, and scan electrode SCj+1) intersect two data electrodes 32 consecutive in the horizontal (row) direction (data electrode De−1 and data electrode De).

In FIG. 9A through FIG. 9E, the value “1” in a checker shows that the discharge cell is lit and the value “0” shows that the discharge cell is unlit.

Hereinafter, a discharge cell in the intersecting part of scan electrode SCj and data electrode De is represented as discharge cell (SCj, De). In FIG. 9A through FIG. 9E, the circled discharge cell is described as a target cell. Thus, in the following description, the target cell is discharge cell (SCj, De).

In the lighting pattern shown in FIG. 9A, the target cell and discharge cell (SCj−1, De) adjacent above the target cell are both unlit. Thus, when the address operation performed on the discharge cell formed on scan electrode SCj−1 switches to the address operation performed on the discharge cell formed on scan electrode SCj, the voltage applied to data electrode De is unchanged and kept at voltage 0 (V).

In this exemplary embodiment, the load value in such a case is set to “0”.

In the lighting pattern of FIG. 9B, the target cell and discharge cell (SCj−1, De) adjacent above the target cell are both lit. Thus, when the address operation on the discharge cell on scan electrode SCj−1 switches to the address operation on the discharge cell on scan electrode SCj, the voltage applied to data electrode De is unchanged and kept at voltage Vd.

In this exemplary embodiment, the load value in such a case is also set to “0”.

In the lighting pattern of FIG. 9C, discharge cell (SCj−1, De) adjacent above the target cell is unlit and the target cell is lit. Thus, when the address operation on the discharge cell on scan electrode SCj−1 switches to the address operation on the discharge cell on scan electrode SCj, the voltage applied to data electrode De changes from voltage 0 (V) to voltage Vd. At this time, the capacitance between the target cell and discharge cell (SCj−1, De) is charged.

In the lighting pattern of FIG. 9C, discharge cell (SCj−1, De−1) diagonal to the target cell on the top left side is unlit and discharge cell (SCj, De−1) adjacent to the target cell on the left side is lit. Thus, when the voltage applied to data electrode De changes from voltage 0 (V) to voltage Vd, the voltage applied to data electrode De−1 changes from voltage 0 (V) to voltage Vd similarly. That is, the voltage applied to data electrode De and the voltage applied to data electrode De−1 change in same phase with each other. At this time, the capacitance between the target cell and discharge cell (SCj, De−1) is not charged.

In this exemplary embodiment, the load value in such a case is set to “1”, for example.

In the lighting pattern of FIG. 9D, discharge cell (SCj−1, De) adjacent above the target cell is unlit and the target cell is lit. Thus, when the address operation on the discharge cell on scan electrode SCj−1 switches to the address operation on the discharge cell on scan electrode SCj, the voltage applied to data electrode De changes from voltage 0 (V) to voltage Vd. At this time, the capacitance between the target cell and discharge cell (SCj−1, De) is charged.

On the other hand, in the lighting pattern of FIG. 9D, discharge cell (SCj−1, De−1) diagonal to the target cell on the top left side is unlit and discharge cell (SCj, De−1) adjacent to the target cell on the left side is also unlit. Thus, when the voltage applied to data electrode De changes from voltage 0 (V) to voltage Vd, the voltage applied to data electrode De−1 is kept at voltage 0 (V). At this time, the capacitance between the target cell and discharge cell (SCj, De−1) is charged.

In this exemplary embodiment, the load value in such a case is set to “2”, for example.

Though not shown, suppose discharge cell (SCj−1, De) adjacent above the target cell is unlit, the target cell is lit, and discharge cell (SCj−1, De−1) diagonal to the target cell on the top left side and discharge cell (SCj, De−1) adjacent to the target cell on the left side are both lit. In this case, when the voltage applied to data electrode De changes from voltage 0 (V) to voltage Vd, the voltage applied to data electrode De−1 is kept at voltage Vd. In this exemplary embodiment, the load value in such a case is set to “2” similarly to that in the lighting pattern of FIG. 9D.

In the lighting pattern of FIG. 9E, discharge cell (SCj−1, De) adjacent above the target cell is unlit and the target cell is lit. Thus, when the address operation on the discharge cell on scan electrode SCj−1 switches to the address operation on the discharge cell on scan electrode SCj, the voltage applied to data electrode De changes from voltage 0 (V) to voltage Vd. At this time the capacitance between the target cell and discharge cell (SCj−1, De) is charged.

On the other hand, in the lighting pattern of FIG. 9E, discharge cell (SCj−1, De−1) diagonal to the target cell on the top left side is lit and discharge cell (SCj, De−1) adjacent to the target cell on the left side is unlit. Thus, when the voltage applied to data electrode De changes from voltage 0 (V) to voltage Vd, the voltage applied to data electrode De−1 changes from voltage Vd to voltage 0 (V). That is, the voltage applied to data electrode De and the voltage applied to data electrode De−1 change in opposite phase with each other. At this time, the capacitance between the target cell and discharge cell (SCj−1, De) is charged with a larger amount than that of the lighting pattern of FIG. 9D.

In this exemplary embodiment, the load value in such a case is set to “3”, for example.

Data load detection circuit 37 of this exemplary embodiment calculates a load value in each discharge cell, based on the image data supplied from image signal processing circuit 36, using the above calculation method. Then, data load detection circuit 37 calculates a line total sum of load values in the discharge cells in one line formed on display electrode pair 24 (i.e. m discharge cells) for each row (line). Further, data load detection circuit 37 calculates the total sum of load values by cumulatively-adding the line total sums in each address period. Further, data load detection circuit 37 subtracts a recovery value from the total sum of load values in a constant cycle (e.g. a cycle equal to that of one address operation).

The total sum of load values calculated in data load detection circuit 37 is output to control signal generation circuit 40. Control signal generation circuit 40 controls the minimum voltage of a selective initializing waveform, i.e. voltage Vi5, based on the total sum of load values immediately before the selective initializing period.

Hereinafter, a description is provided for a specific example of the operation of plasma display apparatus 30 in the exemplary embodiment of the present invention.

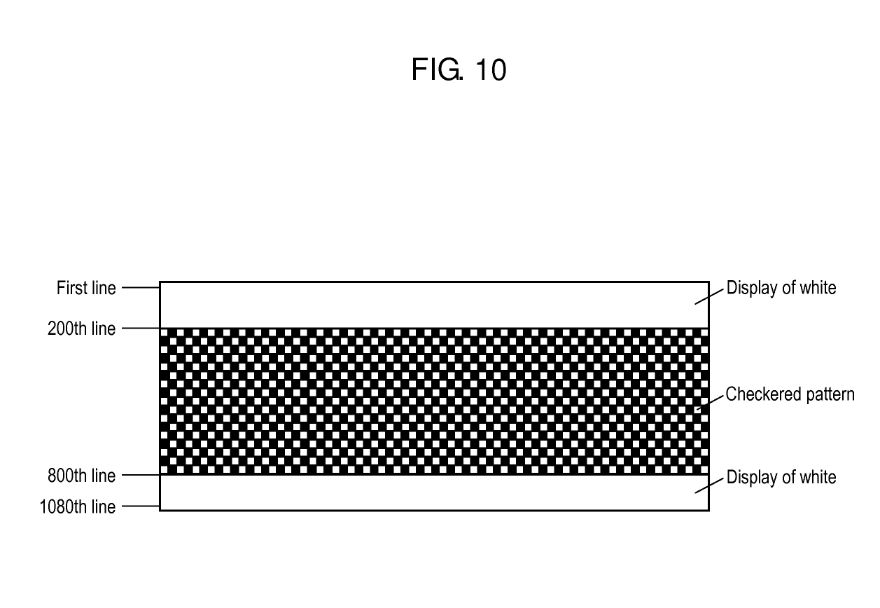

FIG. 10 is a diagram schematically showing an example of an image pattern displayed on panel 10 in plasma display apparatus 30 in accordance with the exemplary embodiment of the present invention.

In the following description, panel 10 has 1080 display electrode pairs 24 and 1920×3 data electrodes 32.

The image of FIG. 10 shows a pattern that has a white region in the first line through the 199th line, a checkered pattern region in the 200th line through the 800th line, and a white region in the 801st line to the 1080th line. In this checkered pattern region, as shown in FIG. 8, a lit discharge cell alternates with an unlit discharge cell in the vertical (column) direction and a lit discharge cell alternates with an unlit discharge cell also in the horizontal (row) direction. In the pattern of FIG. 10, light emission occurs in all the subfields in the white region, and the checkered pattern region is formed of white where light emission occurs in all the subfields and black where no light emission occurs in all the subfields.

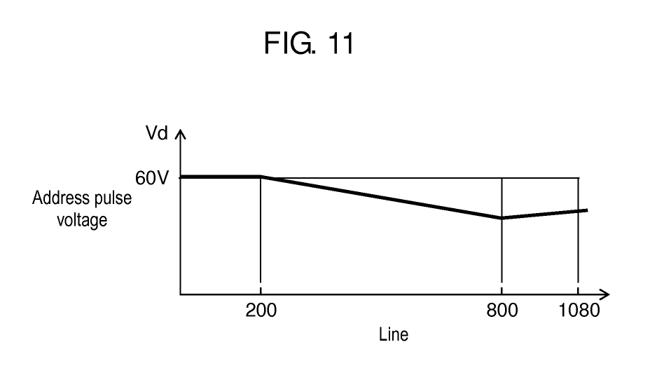

FIG. 11 is a graph schematically showing an example of a voltage drop in an address pulse in plasma display apparatus 30 in accordance with the exemplary embodiment of the present invention.

In FIG. 11, the vertical axis shows an address pulse voltage applied to data electrodes 32; the horizontal axis shows a line in panel 10.

FIG. 11 shows a measurement result of an address pulse voltage applied to data electrode 32 when an image pattern of FIG. 10 is displayed on panel 10.

As described above, in the period from the first line through the 199th line, the electric power consumption in data electrode driver circuit 42 is extremely small. Thus, as shown in FIG. 11, substantially no voltage drop in address pulse voltage Vd occurs in this period.

In contrast, in the period from the 200th line through the 800th line, the electric power consumption in data electrode driver circuit 42 is extremely large. Thus, as shown in FIG. 11, a voltage drop in address pulse voltage Vd occurs in this period. In the example of FIG. 11, while voltage Vd in the 200th line is approximately 60 (V), voltage Vd in the 800th line is approximately 56 (V), which is approximately 4 (V) lower than voltage Vd in the 200th line.

In the period from the 801st line to 1080th line, the electric power consumption in data electrode driver circuit 42 is extremely small. Thus, as shown in FIG. 11, in this period, address pulse voltage Vd gradually recovers toward the original voltage (60 (V)). In the example of FIG. 11, voltage Vd in the 1080th line is approximately 56.5 (V), where voltage Vd in the 801st line has recovered by approximately 0.5 (V).

A drop in address pulse voltage Vd shows a drop in the power supply voltage supplied to data electrode driver circuit 42. If the power supply voltage supplied to data electrode driver circuit 42 drops, voltage Vg applied from data electrode driver circuit 42 to data electrodes 32 in each selective initializing period also drops as well as address pulse voltage Vd.

Data load detection circuit 37 in this exemplary embodiment can accurately estimate a drop in the power supply voltage supplied to data electrode driver circuit 42.

When an image pattern of FIG. 10, for example, is displayed on panel 10, since white is displayed on panel 10 in the period from the first line through the 199th line, the respective discharge cells are lit in the lighting pattern of FIG. 9B. Thus, the load values of the respective discharge cells in the first line through the 199th line are all “0”, and the line total sums of load values are also “0”. Therefore, the total sum of load values in this period is kept at “0”.

During this period, data load detection circuit 37 subtracts a recovery value from the total sum of load values in a constant cycle (e.g. a cycle equal to that of one address operation). However, since the minimum value of the total sum of load values is limited to “0”, the total sum of load values is kept at “0”.

In the period from the 200th line through the 800th line for display of a checkered pattern, the respective discharge cells are lit in the lighting pattern of FIG. 9E. Thus, in approximately a half the number of discharge cells in the 200th line through the 800th line, the load value is “3”. When the number of discharge cells in one line is 1920×3, the line total sum of load values is 3×1920×3/2. Therefore, in the 200th line through the 800th line, the total sum of load values is added with 3×1920×3/2 for each line.

Also in this period, data load detection circuit 37 subtracts a recovery value from the total sum of load values in a constant cycle. However, since the line total sums are larger than recovery values, the total sum of load values gradually increases.

When this checkered pattern is displayed on panel 10, the line total sum of load values takes a maximum value. That is, 3×1920×3/2 is the maximum value of the line total sum.

In the period from the 801st line through the 1080th line, since white is displayed on panel 10, the respective discharge cells are lit in the lighting pattern of FIG. 9B. Thus, the load values of the respective discharge cells in the 801st line through the 1080th line are all “0”, and the line total sums of load values are also “0”. Therefore, during this period, the total sum of load values does not increase.

Also during this period, data load detection circuit 37 subtracts a recovery value from the total sum of load values in a constant cycle. Thus, the total sum of load values gradually decreases.

Thus, in this exemplary embodiment, an increase and a decrease in the total sum of load values substantially correspond to the measured values of the address pulse voltage shown in FIG. 11. Therefore, using the total sum of load values, a drop in voltage Vg in each selective initializing period can be estimated accurately.

In order to compensate for the drop in voltage Vg in each selective initializing period, minimum voltage Vi5 in the selective initializing waveform only needs to be lowered by the voltage equal to the drop in voltage Vg.

For instance, when voltage Vi5=−110 (V) and voltage Vg=60 (V), the electric potential difference (the maximum potential difference) between data electrodes 32 and scan electrodes 22 at the end of the selective initializing period is 170 (V). Thus, when a voltage drop of 3.5 (V) in voltage Vg makes voltage Vg=56.5 (V), voltage Vi5 is set to −113.5 (V). With this setting, the maximum potential difference between data electrodes 32 and scan electrodes 22 at the end of the initializing period can be kept at 170 (V).

In this manner, plasma display apparatus 30 of this exemplary embodiment accurately estimates a drop in voltage Vg in each selective initializing period by calculating the total sum of load values based on the image data in the immediately preceding subfield. Then, the plasma display apparatus lowers minimum voltage Vi5 in the selective initializing waveform by a voltage (voltage ΔVg) equivalent to the drop in voltage Vg.

That is, in plasma display apparatus 30, data load detection circuit 37 calculates load values in the respective discharge cells, based on the image data supplied from image signal processing circuit 36. The data load detection circuit calculates a line total sum of load values in the discharge cells (m discharge cells) in one line formed on display electrode pair 24 for each row (line). Further, the data load detection circuit calculates the total sum of load values by cumulatively-adding the line total sums of load values over all the lines, and subtracts a “recovery value” from the total sum of load values in a constant cycle. The calculation result is transmitted from data load detection circuit 37 to control signal generation circuit 40. Based on the calculation result, control signal generation circuit 40 generates a control signal so as to control minimum voltage Vi5 of a selective initializing waveform. Scan electrode driver circuit 43 generates the selective initializing waveform such that minimum voltage Vi5 is a voltage in response to the control signal, and applies the waveform to scan electrodes 22 in the selective initializing period.

This operation can keep the maximum potential difference between data electrodes 32 and scan electrodes 22 at the end of the selective initializing period to a constant potential difference (e.g. 170 (V)) regardless of the electric power consumption in data electrode driver circuit 42 in the address period of the immediately preceding subfield. Thus, this operation can prevent insufficient adjustment of wall charge generated by the initializing discharge and cause a stable address discharge in the succeeding address period.

In this exemplary embodiment, based on the total sum of load values, voltage Vi5 is controlled in the following manner:

1) When the total sum of load values is smaller than the maximum value of 15%, voltage Vi5 is unchanged from the original voltage;

2) When the total sum of load values is equal to or larger than 15% of the maximum value and smaller than 30% of the maximum value, voltage Vi5 is changed to a voltage lower than the original voltage by 1 (V);

3) When the total sum of load values is equal to or larger than 30% of the maximum value and smaller than 45% of the maximum value, voltage Vi5 is changed to a voltage lower than the original voltage by 2 (V);

4) When the total sum of load values is equal to or larger than 45% of the maximum value and smaller than 60% of the maximum value, voltage Vi5 is changed to a voltage lower than the original voltage by 3 (V);

5) When the total sum of load values is equal to or larger than 60% of the maximum value and smaller than 75% of the maximum value, voltage Vi5 is changed to a voltage lower than the original voltage by 4 (V); and

6) When the total sum of load values is larger than 75% of the maximum value, voltage Vi5 is changed to a voltage lower than the original voltage by 5 (V).

This “maximum value” is the total sum of load values when the checkered pattern of FIG. 8 is displayed in the entire image display area of panel 10. At this time, the line total sum in each of all the lines in panel 10 takes a maximum value. For instance, when panel 10 has 1920×1080 pixels, and 1920×3×1080 discharge cells, this “maximum value” is a value obtained by subtracting a recovery value×1080 from 3×1920×3×½×1080.

In this exemplary embodiment, the recovery value is 5% of the maximum value of the line total sum. For instance, when one line has 1920×3 discharge cells, the recovery value is 3×1920×3×½×0.05.

However, the present invention is not limited to these numerical values. Preferably, each numerical value is set to a value optimal for the characteristics of panel 10, the specifications of plasma display panel 30, or the like.

The driving voltage waveforms of FIG. 3 only show an example in the exemplary embodiment of the present invention, and the present invention is not limited to these driving voltage waveforms.

The circuit configurations of FIG. 4, FIG. 5, and FIG. 6 only show examples in the exemplary embodiment of the present invention, and the present invention is not limited to these circuit configurations.

In the structure described in the exemplary embodiment, an initializing operation is performed on the respective discharge cells, using forced initializing waveforms once in two fields. However, the present invention is not limited to this structure. The frequency of initializing operations using forced initializing waveforms on the respective discharge cells may be once in three or more fields.

Each circuit block shown in the exemplary embodiment of the present invention may be formed as an electric circuit that performs each operation shown in the exemplary embodiment, or formed of a microcomputer, for example, programmed so as to perform the similar operations.

In the example described in the exemplary embodiment of the present invention, one field is formed of 10 subfields. However, in the present invention, the number of subfields forming one field is not limited to the above number. Increasing the number of subfields, for example, can further increase the number of gradations displayable on panel 10. Alternatively, decreasing the number of subfields can shorten the time taken to drive panel 10.

In the example described in the exemplary embodiment of the present invention, one pixel is formed of discharge cells of three colors, i.e. red, green, and blue. Also a panel that has pixels, each formed of discharge cells of four or more colors, can use the configurations shown in the exemplary embodiment of the present invention and offer the similar advantages.

The specific numerical values shown in the exemplary embodiment of the present invention are set based on the characteristics of panel 10 that has a 50-inch screen and 1024 display electrode pairs 24, and only show examples in the exemplary embodiment. The present invention is not limited to these numerical values. Preferably, each numerical value is set optimally for the specifications of the panel, the characteristics of the panel, the specifications of the plasma display apparatus, or the like. Variations are allowed for each numerical value within the range in which the above advantages can be obtained. The number of subfields forming one field, the luminance weights of the respective subfields, or the like is not limited to the values shown in the exemplary embodiment of the present invention. The subfield structure may be switched in response to an image signal, for example.

### INDUSTRIAL APPLICABILITY

The present invention can enhance the contrast of the display image and thus the image display quality in a plasma display apparatus, and cause a stable address discharge by sufficiently adjusting the wall charge generated by an initializing discharge even in the plasma display apparatus that includes a large, high-definition panel where an increased number of electrodes are likely to increase the impedance when the electrodes are driven. Thus, the present invention is useful as a driving method for a plasma display apparatus, and as a plasma display apparatus.

### REFERENCE MARKS IN THE DRAWINGS

10 Panel
21 Front substrate
22 Scan electrode
23 Sustain electrode
24 Display electrode pair
25, 33 Dielectric layer
26 Protective layer
30 Plasma display apparatus
31 Rear substrate
32 Data electrode
34 Barrier rib
35, 35R, 35G, 35B Phosphor layer
36 Image signal processing circuit
37 Data load detection circuit
40 Control signal generation circuit
42 Data electrode driver circuit
43 Scan electrode driver circuit
44 Sustain electrode driver circuit
50 Sustain pulse generation circuit
51 Initializing waveform generation circuit
52 Scan pulse generation circuit
53, 54, 55 Miller integration circuit
56 Power recovery circuit
57 Clamp circuit
Q1, Q2, Q3, Q5, Q6, Q7, Q11, Q12, Q13, Q14, QH1-QHn, QL1-QLn, Q91H1-Q91Hm, Q91L1-Q91Lm Switching element
C1, C2, C3, C11, C31 Capacitor
Di1, Di2, Di31 Diode
R1, R2, R3 Resistor
L11 Inductor
L1, L1′ Up-ramp voltage
L2, L4 Down-ramp voltage
L3 Erasing ramp voltage

1. A driving method for a plasma display apparatus,
the plasma display apparatus including a plasma display panel, the plasma display panel having a plurality of discharge cells, each of the discharge cells having a display electrode pair and a data electrode, the display electrode pair including a scan electrode and a sustain electrode,
the plasma display apparatus displaying gradations on the plasma display panel in a manner such that a plurality of subfields, each having an initializing period, an address period, and a sustain period, is set in one field,
the driving method comprising:
in the initializing period, performing one of a forced initializing operation and a selective initializing operation, the forced initializing operation causing an initializing discharge in the discharge cells, the selective initializing operation causing an initializing discharge selectively in the discharge cells having an address discharge in an immediately preceding subfield;
setting a specified-cell initializing subfield and a selective initializing subfield in the one field, the specified-cell initializing subfield including an initializing period where the forced initializing operation is performed on specified discharge cells and the selective initializing operation is performed on other discharge cells, the selective initializing subfield including an initializing period where the selective initializing operation is performed on all the discharge cells;
in the selective initializing period, applying a down-ramp waveform voltage to the scan electrodes and applying a positive voltage to the data electrodes; and
in the selective initializing subfield, based on a load calculated when the data electrodes are driven in the address period of the immediately preceding subfield, controlling a minimum voltage of the down-ramp waveform voltage.

2. The driving method for the plasma display apparatus of claim 1, wherein
a load value of each discharge cell is calculated based on image data representing light emission or no light emission in each discharge cell in each subfield, the image data being set in response to an image signal, and
by cumulatively-adding the load values, the load when the data electrodes are driven in the address period is calculated.

3. The driving method for the plasma display apparatus of claim 1, wherein the minimum voltage of the down-ramp waveform voltage is lowered in the selective initializing period of a subfield where a magnitude of the load exceeds a threshold.

4. A plasma display apparatus comprising:
a plasma display panel having a plurality of discharge cells, each of the discharge cells having a display electrode pair and a data electrode, the display electrode pair including a scan electrode and a sustain electrode; and
a driver circuit for displaying gradations on the plasma display panel in a manner such that a plurality of subfields, each having an initializing period, an address period, and a sustain period, is set in one field,
wherein the driver circuit performs one of a forced initializing operation and a selective initializing operation in the initializing period, the forced initializing operation causing an initializing discharge in the discharge cells, the selective initializing operation causing an initializing discharge selectively in the discharge cells having an address discharge in an immediately preceding subfield,
a specified-cell initializing subfield and a selective initializing subfield are set in the one field, the specified-cell initializing subfield including an initializing period where the forced initializing operation is performed on specified discharge cells and the selective initializing operation is performed on other discharge cells, the selective initializing subfield including an initializing period where the selective initializing operation is performed on all the discharge cells,
in the selective initializing period, the driver circuit applies a down-ramp waveform voltage to the scan electrodes and applies a positive voltage to the data electrodes, and
in the selective initializing subfield, based on a load calculated when the data electrodes are driven in the address period of the immediately preceding subfield, a minimum voltage of the down-ramp waveform voltage is controlled.
